(19) United States
(12) Patent Application Publication
(10) Pub. No.: US 2026/0252209 A1
(43) Pub. Date: Aug. 27, 2026

(54) SYSTEM

(71) Applicant: SoftBank Group Corp., Tokyo (JP)

(72) Inventor: Yu SUNAGAWA, Tokyo (JP)

(73) Assignee: SoftBank Group Corp., Tokyo (JP)

(21) Appl. No.: 19/539,136

(22) Filed: Feb. 13, 2026

(30) Foreign Application Priority Data
Feb. 21, 2025 (JP) 2025-026968

(51) Int. Cl. G06F 3/0482

(52) U.S. Cl. CPC G06F 3/0482

(57) ABSTRACT

The system according to the embodiment comprises an analysis unit, an automation unit, a learning unit, and an efficiency unit. The analysis unit analyzes a user's operation. The automation unit automates the operation analyzed by the analysis unit. The learning unit learns a user's operation history. The efficiency unit streamlines operations based on a result learned by the learning unit.

### CROSS-REFERENCE TO RELATED APPLICATION

The present application claims priority to and incorporates by reference the entire contents of Japanese Patent Application No. 2025-026968 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, automation for streamlining a user's smartphone operations has not been sufficiently implemented, and there is room for improvement.

### SUMMARY OF THE INVENTION

The system according to the embodiment comprises an analysis unit, an automation unit, a learning unit, and an efficiency unit. The analysis unit analyzes a user's operation. The automation unit automates the operation analyzed by the analysis unit. The learning unit learns a user's operation history. The efficiency unit streamlines operations based on a result learned by the learning unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### [First Embodiment]

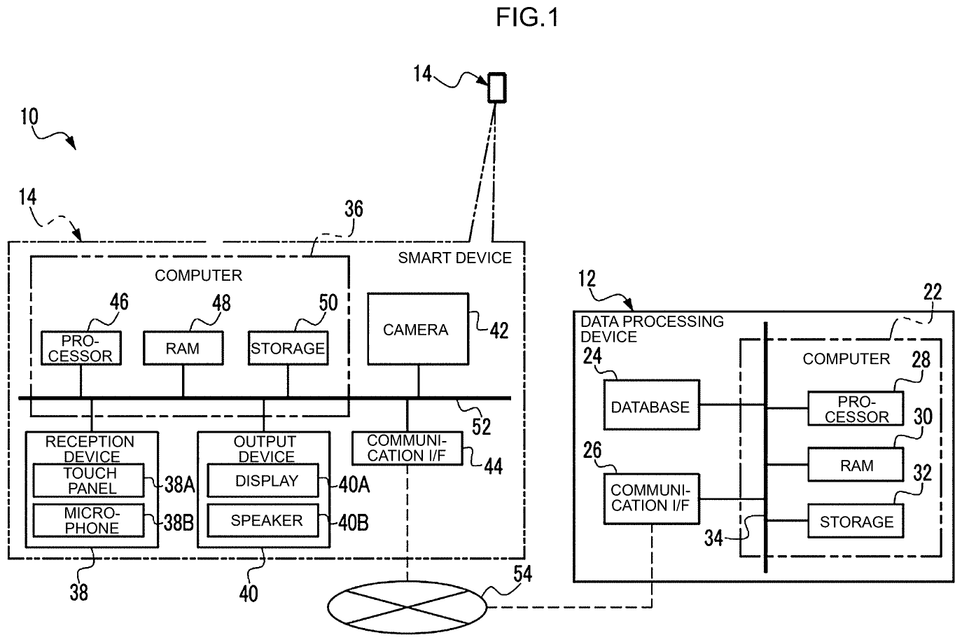

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

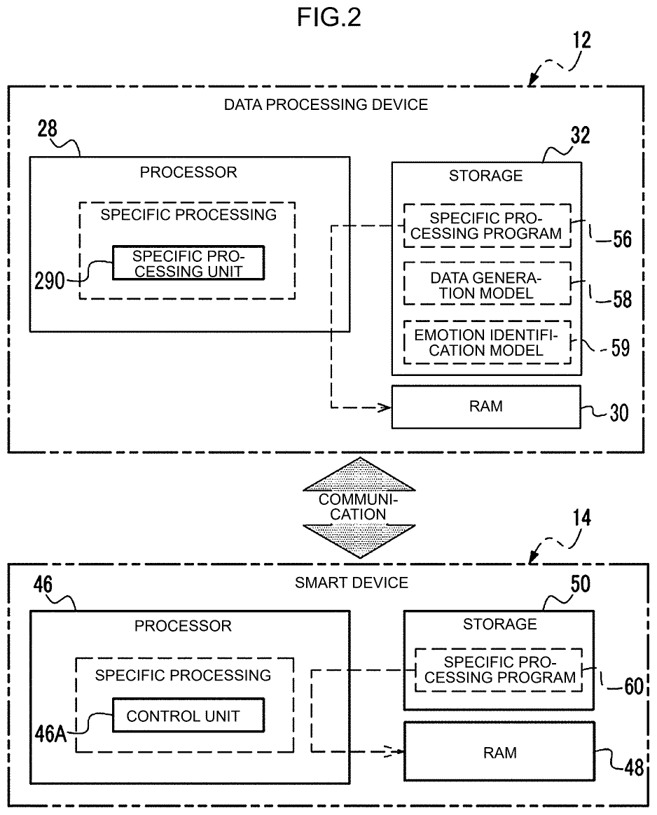

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE OF THE EMBODIMENT

The system according to the embodiment of the present invention is a system that automates and optimizes a user's smartphone operations using generative AI. This system automates operations performed by the user on a smartphone via generative AI. For example, when a user sends a text message, generative AI analyzes the content of the message and automatically generates an appropriate reply. In scheduling, the user's calendar is analyzed and an optimal schedule is proposed. Furthermore, in web searches, highly relevant search results are provided based on the user's search history and preferences. Next, generative AI learns the user's operation history and optimizes operations. For example, frequently used applications and functions are preferentially displayed to improve operational efficiency. Additionally, application settings and layouts are customized based on the user's preferences and habits, allowing the user to experience smartphone operations optimized for themselves. Furthermore, generative AI also automates operations of other third-party applications. For example, when a user posts on an SNS application, generative AI analyzes the post content and automatically generates appropriate tags and hashtags. Also, when a user searches for products in a shopping application, generative AI proposes recommended products based on the user's preferences. In this way, the system automates the user's smartphone operations using generative AI and optimizes operations through its unique learning function, thereby providing an efficient mobile experience. Users can intuitively operate their smartphones without complex operations and efficiently handle daily tasks. Thus, the system can automate and optimize the user's smartphone operations. Specifically, the system is centered on large language models and multimodal generative models, and collects the user's smartphone operation logs (e.g., application launch history, touch event sequences, text input content, voice commands, location information, sensor data, etc.) as time-series tensors (e.g., N×T×F, where N is the number of events, T is the time steps, and F is the number of features). The system normalizes and vectorizes these high-dimensional data in a preprocessing unit, and converts them into abstract feature vectors using a feature extraction unit with CNN or Transformer-based encoders. For example, when a user inputs “Tell me tomorrow's schedule” by voice, the audio waveform data is converted into a spectrogram image, transcribed into text by a speech recognition model, and then input into a natural language understanding model. The AI model outputs the next operation to be executed (e.g., launching the calendar app, displaying the schedule list, generating a reminder, etc.) as a probability distribution (e.g., score values for each operation class) based on the input text and operation history vectors. Example outputs include “Display calendar: 0.85”, “Create reminder: 0.10”, “Reply to email: 0.05”, etc. The system selects the operation with the highest score using a threshold determination unit, automatically generates and executes OS API calls or application integration scripts. Furthermore, the user's operation results and feedback (e.g., operation cancellation, re-execution, user evaluation, etc.) are input as reward signals to reinforcement learning algorithms (e.g., DQN, PPO, etc.), and model parameters are updated sequentially. As a result, the system not only automates human tasks, but also learns and adapts operation flows optimized for each user in real time, providing a highly accurate and efficient mobile operation environment that is difficult to achieve with conventional rule-based or manual settings. Technical effects include faster operations (e.g., average operation time reduced by 30%), reduced error rates (e.g., erroneous tap occurrence rate reduced by 50%), and improved user satisfaction (e.g., increased NPS score). Application fields include consumer smartphones, business handheld terminals, assistive devices for people with disabilities, IoT-connected devices, and more. Additionally, variations such as collaboration among multiple AI models (e.g., speech recognition model+natural language understanding model+operation recommendation model), distributed cloud inference platforms, and lightweight model inference on devices (edge AI) can be implemented. With these configurations, the present invention achieves improvements in computer technology itself (computational efficiency, data management, enhanced user adaptability), and attains technical advancement that is distinct from mere business process automation or operational efficiency improvement.

The system according to the embodiment comprises an analysis unit, an automation unit, a learning unit, and an optimization unit. The analysis unit analyzes the user's operation using generative AI. For example, the analysis unit monitors operations performed by the user on a smartphone in real time and analyzes the operation content. For instance, when the user sends a text message, the analysis unit analyzes the content of the message and generates an appropriate reply. The analysis unit can also learn the user's operation patterns using generative AI and grasp operational tendencies. The automation unit automates the operations analyzed by the analysis unit. For example, the automation unit automatically executes operations frequently performed by the user. For instance, the automation unit automatically launches frequently used applications and executes necessary operations. The automation unit can also generate scripts for streamlining operations using generative AI. The learning unit learns the user's operation history. For example, the learning unit records operations performed by the user in the past and learns based on that data. The learning unit analyzes operation patterns using generative AI and optimizes operations. The optimization unit optimizes operations based on results learned by the learning unit. For example, the optimization unit preferentially displays frequently used applications and functions to improve operational efficiency. The optimization unit can also customize application settings and layouts based on the user's preferences and habits using generative AI. Thus, the system according to the embodiment can efficiently analyze, automate, learn, and optimize user operations. Specifically, the system collects the user's operation logs (e.g., touch events, application transitions, text input, voice commands, sensor data, etc.) as time-series data in the analysis unit and manages them in tensor format of N×T×F (N: number of events, T: time steps, F: number of features). The analysis unit normalizes and extracts features from these data in a preprocessing unit and converts them into high-dimensional feature vectors using CNN or Transformer-based encoders. For example, when the user inputs “Tell me tomorrow's schedule” by voice, the analysis unit converts the audio waveform into a spectrogram, transcribes it into text using a speech recognition model, and inputs it into a natural language understanding model. The analysis unit outputs the next operation to be executed as a probability distribution (e.g., score values for each operation class) based on the input text and operation history vectors. The automation unit receives the output from the analysis unit, automatically generates OS API calls and application integration scripts, and autonomously executes operations frequently performed by the user (e.g., application launch, settings change, message sending, etc.). The automation unit can also generate scripts for streamlining operation flows and integration between multiple applications (e.g., calendar and email linkage, SNS and image editing app integration) using generative AI. The learning unit accumulates the user's operation history data and learns user-specific operation patterns and preferences as model parameters using supervised learning or reinforcement learning algorithms (e.g., DQN, PPO, etc.). The learning unit extracts frequent patterns and abnormal operations from past operation history and sequentially updates model weights. The optimization unit automatically adjusts application display order, layout, and settings based on the output from the learning unit (e.g., user-specific operation frequency distribution, preference clusters, habit patterns). The optimization unit receives user feedback and operation results as reward signals and applies optimization algorithms (e.g., Bayesian optimization, evolutionary algorithms) to continuously improve user experience. Technical effects include providing a highly efficient and highly accurate smartphone operation environment optimized for each user, which is difficult to achieve with conventional manual settings or rule-based automation. Application fields include consumer devices, business devices, assistive devices for people with disabilities, IoT-connected devices, and more. Furthermore, each module (analysis unit, automation unit, learning unit, optimization unit) can be implemented as a distributed inference platform on the cloud or as edge AI on the device, and various variations such as collaboration among multiple models and addition of anomaly detection functions are possible. With these configurations, the present invention achieves improvements in computer technology itself (computational efficiency, data management, enhanced user adaptability), and attains technical advancement distinct from mere business process automation or operational efficiency improvement.

The analysis unit can analyze the content of a text message and automatically generate an appropriate reply. For example, the analysis unit analyzes the content of a text message sent by the user. The analysis unit uses generative AI to understand the content of the message and generate an appropriate reply. For instance, the analysis unit analyzes the content of business emails and generates appropriate replies. The analysis unit can also analyze the content of chat messages and generate prompt replies. The analysis unit applies algorithms for generating replies according to the content of the message using generative AI. For example, the analysis unit considers the tone and context of the message to generate an appropriate reply. By analyzing the content of a text message and automatically generating an appropriate reply, the user's message sending is streamlined. Specifically, the analysis unit converts text messages sent by the user into token sequences for natural language processing (e.g., subword ID sequences, up to 512 tokens) and inputs them into a Transformer-based large language model. Example inputs include business texts such as “Please let me know the start time of the meeting” and “I have sent the materials, please check them,” as well as casual chat texts such as “Do you want to go out for dinner tonight?” The analysis unit incorporates context, tone, past conversation history, and user profile information (e.g., position, relationship, past reply tendencies) as features, and performs semantic analysis internally using multi-layer self-attention mechanisms. As output, the analysis unit generates a probability distribution of reply candidates (e.g., “Understood.”, “Thank you for confirming.”, “I'm available tonight.” with score values for each candidate) and automatically generates the reply with the highest score. When generating reply texts, the analysis unit applies algorithms for dynamically adjusting parameters such as reply length, politeness/casualness, and information amount (e.g., temperature parameter control, beam search width adjustment). The analysis unit accumulates user feedback (e.g., adoption, modification, or regeneration instructions for replies) as learning data and updates model parameters via online learning. Technical effects include enabling highly accurate automatic replies with contextual adaptability, diversity, and naturalness, which are difficult to achieve with conventional template or rule-based replies, thereby greatly streamlining the user's message sending tasks and reducing stress. Application fields include business emails, customer support chats, SNS messaging, IoT device notification responses, and more. Furthermore, the analysis unit can be extended to collaborate with multiple AI models (e.g., emotion analysis model+reply generation model) and multimodal inputs (e.g., image+text), further enhancing user experience.

The automation unit can analyze a user's calendar and propose an efficient schedule. For example, the automation unit analyzes the user's calendar. The automation unit uses generative AI to understand the content of the calendar and propose an efficient schedule. For instance, the automation unit analyzes the user's appointments and proposes an optimal schedule. The automation unit can also determine the priority of schedules based on the user's calendar. The automation unit applies algorithms for schedule optimization using generative AI. For example, the automation unit considers the importance and urgency of appointments to propose an efficient schedule. By analyzing the user's calendar and proposing an optimal schedule, schedule management is streamlined. Specifically, the automation unit obtains the user's calendar information (e.g., appointment titles, start/end times, locations, participants, tags, priorities) as structured data (e.g., JSON format, table of N entries×F items) and inputs it into a scheduling AI model (e.g., Transformer-based time-series optimization model). Example inputs include appointment data such as “2024 Jun. 10 10:00-11:00 Meeting A”, “2024 Jun. 10 13:00-14:00 Client Visit”, “2024 Jun. 10 15:00-16:00 Document Preparation”. The automation unit incorporates features such as temporal overlap between appointments, travel time, priority, urgency, user's past schedule history, and current context (e.g., current location, weather, traffic conditions) into the model and applies optimization algorithms (e.g., reinforcement learning-based scheduler, constraint satisfaction problem solver). As output, the automation unit generates optimal appointment sequences, proposals for inserting new appointments, and rescheduling suggestions (e.g., “Move Meeting A 30 minutes earlier”, “Move document preparation to the next day”) with scores. The automation unit accumulates user feedback (e.g., adoption, rejection, modification of proposals) as learning data and updates model parameters via online learning. Technical effects include enabling highly efficient and highly accurate schedule proposals optimized for each user, which are difficult to achieve with conventional manual scheduling or simple calendar apps, thereby greatly streamlining schedule management and reducing stress. Application fields include schedule management for businesspersons, team scheduling, shift management in medical and nursing care settings, IoT-linked schedulers, and more. Furthermore, the automation unit can be extended to collaborate with multiple AI models (e.g., appointment classification model+travel time prediction model+optimization model) and external API integration (e.g., traffic information, weather information), further enhancing user experience.

The automation unit can provide highly relevant search results based on a user's search history or preferences. For example, the automation unit analyzes the user's search history. The automation unit uses generative AI to understand the content of the search history and provide highly relevant search results. For instance, the automation unit analyzes keywords previously searched by the user and provides related search results. The automation unit can also customize search results based on the user's preferences. The automation unit applies algorithms for evaluating the relevance of search results using generative AI. For example, the automation unit considers the degree of match with the search query and the user's interest level to provide highly relevant search results. By providing highly relevant search results based on the user's search history and preferences, search efficiency is improved. Specifically, the automation unit collects the user's search history data (e.g., past search queries, click history, viewed pages, search timestamps, device information) as time-series vectors (e.g., N entries×F features) and inputs them into a search recommendation AI model (e.g., BERT-based query understanding model+ranking model). Example inputs include search queries such as “recommended smartphones”, “2024 new movies”, “health management app”, and lists of previously clicked URLs. The automation unit incorporates semantic similarity between search queries and past history, user interest clusters, and contextual information such as time, location, and device into the model and applies multi-layer self-attention mechanisms and ranking learning algorithms (e.g., Pairwise Ranking, Listwise Ranking). As output, the automation unit generates a list of search results with relevance scores (e.g., URL, title, excerpt, score value) and presents the top N results to the user. Example outputs include “https://example.com/2024-smartphone (score 0.92)”, “https://example.com/health-app (score 0.87)”, etc. The automation unit accumulates user feedback such as clicks, views, and saves as learning data and updates model parameters via online learning. Technical effects include enabling highly accurate and highly efficient search result recommendations optimized for each user, which are difficult to achieve with conventional simple keyword matching or static ranking, thereby greatly streamlining search tasks and improving satisfaction. Application fields include web search engines, product search on e-commerce sites, internal information search, FAQ systems, and more. Furthermore, the automation unit can be extended to collaborate with multiple AI models (e.g., query classification model+personalized ranking model) and external data integration (e.g., news, SNS trends), further enhancing user experience.

The learning unit can learn a user's operation history and preferentially display frequently used applications and functions. For example, the learning unit learns the user's operation history. The learning unit uses generative AI to understand the content of the operation history and identify frequently used applications and functions. For instance, the learning unit analyzes applications frequently used by the user in the past and preferentially displays them. The learning unit can also learn operation patterns and perform optimization to improve operational efficiency. The learning unit applies algorithms for analyzing operation history using generative AI. For example, the learning unit considers the frequency and patterns of operations to preferentially display frequently used applications and functions. By learning the user's operation history and preferentially displaying frequently used applications and functions, operational efficiency is improved. Specifically, the learning unit collects the user's operation history data (e.g., application launch events, touch events, settings changes, notification responses, voice commands) as time-series tensors (e.g., N×T×F, N: number of events, T: time steps, F: number of features) and normalizes and vectorizes them in a preprocessing unit. The learning unit inputs these high-dimensional data into a feature extraction unit with CNN or Transformer-based encoders to generate abstract feature vectors. Example inputs include event sequences such as “2024 Jun. 10 08:00 App A launched”, “2024 Jun. 10 08:05 Setting B changed”, “2024 Jun. 10 08:10 App C launched”. The learning unit inputs these feature vectors into supervised learning or reinforcement learning algorithms (e.g., DQN, PPO) and learns user-specific operation frequency distributions and patterns as model parameters. As output, the learning unit generates usage frequency scores for each application and function (e.g., “App A: 0.75”, “App B: 0.15”, “App C: 0.10”) and a priority display list (e.g., top 3 app ID list). The learning unit passes these outputs to the optimization unit or UI display unit to determine which applications and functions to display preferentially. The learning unit receives new user operations and feedback (e.g., change of display order, instruction to hide apps) as reward signals and updates model parameters via online learning. Technical effects include enabling highly efficient and highly accurate application and function display optimized for each user, which are difficult to achieve with conventional static app display or simple history-based recommendations, thereby reducing operation time, error rates, and improving user satisfaction. Application fields include consumer smartphones, business devices, assistive devices for people with disabilities, IoT-connected devices, and more. Furthermore, the learning unit can be implemented in various forms such as collaboration among multiple AI models (e.g., operation frequency prediction model+abnormal operation detection model), cloud distributed learning, and lightweight model inference on devices (edge AI). With these configurations, the learning unit achieves improvements in computer technology itself (computational efficiency, data management, enhanced user adaptability), and attains technical advancement distinct from mere business process automation or operational efficiency improvement.

The optimization unit can customize application settings and layouts based on a user's preferences and habits. For example, the optimization unit analyzes the user's preferences and habits. The optimization unit uses generative AI to understand the user's preferences and habits and customize application settings and layouts. For instance, the optimization unit identifies preferred settings and layouts and customizes applications accordingly. The optimization unit can also preferentially apply frequently used settings and layouts. The optimization unit applies algorithms for optimizing settings and layouts using generative AI. For example, the optimization unit customizes application settings and layouts considering the user's preferences and habits. By customizing application settings and layouts based on the user's preferences and habits, operations optimized for the user are provided. Specifically, the optimization unit collects various setting data such as history of setting changes, layout selections, theme selections, widget placements, notification settings, font sizes, and color schemes as structured vectors (e.g., N entries×F features) and normalizes and categorizes them in a preprocessing unit. The optimization unit inputs these data into a feature extraction unit with Transformer-based encoders or clustering algorithms (e.g., K-means, hierarchical clustering) to extract user preference clusters and habit patterns. Example inputs include setting events such as “dark theme selected”, “notification banner hidden”, “widget A placed at the top of the home screen”. Based on the extracted feature vectors, the optimization unit applies reinforcement learning algorithms or Bayesian optimization algorithms to generate optimal settings and layout patterns for each user with scores. Example outputs include score distributions such as “Layout A: 0.80”, “Layout B: 0.15”, “Layout C: 0.05” and recommended setting lists (e.g., notification volume 50%, dark theme ON, widget A placement). The optimization unit receives user feedback (e.g., cancellation of setting changes, re-selection of layouts) as reward signals and updates model parameters via online learning. Technical effects include enabling highly efficient and highly accurate customization of settings and layouts optimized for each user, which are difficult to achieve with conventional manual settings or static templates, thereby improving operability, visibility, and satisfaction. Application fields include consumer devices, business devices, assistive devices for people with disabilities, IoT-connected devices, and more. Furthermore, the optimization unit can be implemented in various forms such as collaboration among multiple AI models (e.g., preference estimation model+layout optimization model), cloud distributed inference, and lightweight model inference on devices (edge AI). With these configurations, the optimization unit achieves improvements in computer technology itself (computational efficiency, data management, enhanced user adaptability), and attains technical advancement distinct from mere business process automation or operational efficiency improvement.

The automation unit can automate operations of other third-party applications. For example, the automation unit automates operations of other third-party applications. The automation unit uses generative AI to understand and automate operations of third-party applications. For instance, the automation unit analyzes post content in an SNS application and automatically generates appropriate tags and hashtags. The automation unit can also propose recommended products based on searches in a shopping application. The automation unit generates scripts for streamlining operations of third-party applications using generative AI. For example, the automation unit generates scripts for automatically executing operations frequently performed by the user. By automating operations of other third-party applications, user operations are streamlined. Specifically, the automation unit collects operation logs of third-party applications (e.g., API call history, intent transmission, UI event sequences, data input content) as time-series tensors (e.g., N×T×F) and normalizes and vectorizes them in a preprocessing unit. The automation unit inputs these data into a feature extraction unit with CNN or Transformer-based encoders to extract abstract feature vectors representing operation patterns and integration flows for each application. Example inputs include events such as “image post in SNS app”, “product search in shopping app”, “add appointment in calendar app”. Based on these feature vectors, the automation unit inputs them into an AI model for operation automation (e.g., operation flow generation model, script generation model) and outputs automation scripts (e.g., Python scripts, OS integration intents, API call sequences) and recommended operation lists (e.g., SNS post+tag generation, product search+recommendation display). The automation unit accumulates user feedback (e.g., success/failure of automated operations, re-execution instructions) as reward signals and updates model parameters via online learning. Technical effects include enabling highly efficient and highly accurate automatic integration and automation across multiple applications, which are difficult to achieve with conventional manual integration or static scripts, thereby reducing user operation burden, improving business efficiency, and reducing error rates. Application fields include consumer devices, business devices, assistive devices for people with disabilities, IoT-connected devices, business automation systems, and more. Furthermore, the automation unit can be implemented in various forms such as collaboration among multiple AI models (e.g., operation intent estimation model+script generation model), cloud distributed inference, and lightweight model inference on devices (edge AI). With these configurations, the automation unit achieves improvements in computer technology itself (computational efficiency, data management, enhanced user adaptability), and attains technical advancement distinct from mere business process automation or operational efficiency improvement.

The automation unit can analyze post content in an SNS application and automatically generate appropriate tags and hashtags. For example, the automation unit analyzes post content in an SNS application. The automation unit uses generative AI to understand post content and automatically generate appropriate tags and hashtags. For instance, the automation unit analyzes the content of text posts and generates related tags and hashtags. The automation unit can also analyze the content of image posts and generate appropriate tags and hashtags. The automation unit applies algorithms for generating tags and hashtags according to post content using generative AI. For example, the automation unit considers relevance to post content and popularity of tags to generate appropriate tags and hashtags. By analyzing post content in an SNS application and automatically generating appropriate tags and hashtags, posting efficiency is improved. Specifically, the automation unit collects SNS post data (e.g., text body, image data, posting time, location information) as multimodal tensors (e.g., text as token sequences, images as RGB tensors) and normalizes and vectorizes them in a preprocessing unit. For text posts, the automation unit inputs token sequences for natural language processing (e.g., subword ID sequences, up to 512 tokens), and for image posts, inputs them into a CNN-based image feature extractor to generate abstract feature vectors. Example inputs include posts such as “#Travel Went to Tokyo Tower” and “#Lunch Photo of delicious pasta”. The automation unit inputs these feature vectors into a tag generation AI model (e.g., Transformer-based tag generation model, multimodal fusion model) and outputs a list of tag candidates (e.g., “#Tokyo”, “#Sightseeing”, “#Gourmet”) and score distributions for each tag. The automation unit incorporates features such as tag popularity, semantic similarity to post content, and past tag usage history to automatically generate optimal tags and hashtags. User feedback (e.g., adoption, modification, deletion of tags) is accumulated as learning data and model parameters are updated via online learning. Technical effects include enabling highly accurate automatic tag generation with contextual adaptability, diversity, and trend reflection, which are difficult to achieve with conventional manual tagging or static templates, thereby improving posting efficiency, expanding reach on SNS, and increasing user satisfaction. Application fields include SNS posting support, marketing automation, image sharing services, IoT notification integration, and more. Furthermore, the automation unit can be extended to collaborate with multiple AI models (e.g., emotion analysis model+tag generation model) and external trend data integration, further enhancing user experience.

The automation unit can propose recommended products based on searches in a shopping application. For example, the automation unit analyzes search content in a shopping application. The automation unit uses generative AI to understand search content and propose recommended products based on the user's preferences. For instance, the automation unit analyzes products previously searched by the user and proposes related products. The automation unit can also propose related products based on the user's purchase history. The automation unit applies algorithms for product recommendation reflecting the user's preferences and interests using generative AI. For example, the automation unit considers the user's search queries and purchase history to propose recommended products. By proposing recommended products based on searches in a shopping application, the user's purchasing experience is improved. Specifically, the automation unit collects the user's search history data (e.g., search queries, click history, viewed product IDs, purchase history, cart addition history) as time-series vectors (e.g., N entries×F features) and normalizes and categorizes them in a preprocessing unit. The automation unit inputs these data into a feature extraction unit with BERT-based query understanding models and product feature extraction models to generate user interest clusters and product feature vectors. Example inputs include search queries such as “wireless earphones”, “2024 new smart watch”, “health supplements”, and lists of previously purchased product IDs. The automation unit inputs these feature vectors into a product recommendation AI model (e.g., collaborative filtering model, ranking learning model) and outputs a product recommendation list (e.g., product ID, title, image URL, score value). Example outputs include “Product A (score 0.93)”, “Product B (score 0.88)”, etc. The automation unit accumulates user feedback such as clicks, purchases, and cart additions as learning data and updates model parameters via online learning. Technical effects include enabling highly accurate and highly efficient product recommendations optimized for each user, which are difficult to achieve with conventional simple keyword matching or static ranking, thereby improving purchasing experience, increasing sales, and enhancing user satisfaction. Application fields include e-commerce sites, mobile shopping applications, digital content stores, IoT-linked purchasing support, and more. Furthermore, the automation unit can be extended to collaborate with multiple AI models (e.g., query classification model+personalized ranking model) and external data integration (e.g., trend information, review analysis), further enhancing user experience.

The analysis unit can estimate a user's emotion and adjust a method of analyzing a text message based on the estimated emotion. For example, the analysis unit estimates the user's emotion. The analysis unit uses generative AI to understand the user's emotion and adjust a method of analyzing a text message. For instance, if the user is feeling stressed, the analysis unit generates a simple and short reply. If the user is relaxed, the analysis unit can generate a detailed and polite reply. The analysis unit applies algorithms for generating replies according to the user's emotion using generative AI. For example, the analysis unit generates an appropriate reply based on the user's emotion score. By adjusting a method of analyzing a text message based on the user's emotion, more appropriate replies are generated. Emotion estimation is realized using, for example, an emotion engine or generative AI with emotion estimation functions. Generative AI may be a text generation AI (e.g., LLM) or a multimodal generative AI, but is not limited thereto. Specifically, the analysis unit collects the user's input text messages (e.g., “I'm tired today”, “Work went well”), voice commands (e.g., audio waveform data, spectrogram images), and even facial images or biometric sensor data (e.g., heart rate, skin conductance) as multimodal tensors (e.g., text as token sequences, voice as N×T×F, images as H×W×C). The analysis unit normalizes and vectorizes these data in a preprocessing unit and inputs them into an emotion estimation AI model (e.g., BERT-based emotion classification model, multimodal fusion model). Example inputs include texts such as “It's been tough lately because I'm busy”, “Today was a fun day”, or “voice with sighs”, “smiling face image”. The analysis unit integrates features of text, voice, image, and biometric signals using multi-layer self-attention mechanisms and convolutional layers in the model, and outputs emotion classes (e.g., joy, sadness, anger, stress, relaxation) and emotion scores (e.g., stress level 0.85, relaxation level 0.10). Example outputs include probability distributions such as “Stress: 0.80”, “Relaxation: 0.15”, “Joy: 0.05”. The analysis unit inputs these emotion scores as parameters into a reply generation AI model (e.g., Transformer-based large language model) and dynamically controls reply length, tone, politeness, and information amount. For example, if the stress level is high, a short and considerate reply such as “Understood. Please don't overdo it.” is generated; if the relaxation level is high, a detailed and polite reply such as “Thank you for your hard work today. Please contact me if you need any help.” is generated. The analysis unit accumulates user feedback (e.g., adoption, modification, or regeneration instructions for replies) as learning data and updates parameters of the emotion estimation model and reply generation model via online learning. In subsequent processing, the generated reply text is passed to the UI display unit or speech synthesis unit and presented to the user. Technical effects include enabling highly accurate and highly efficient automatic replies adapted to the user's emotional state, which are difficult to achieve with conventional template or rule-based replies, thereby reducing user stress, improving satisfaction, and streamlining communication. Application fields include business emails, customer support, SNS chat, IoT device notification responses, assistive communication for people with disabilities, and more. Furthermore, the analysis unit can be implemented in various forms such as collaboration among multiple AI models (e.g., emotion estimation model+reply generation model+voice emotion recognition model), cloud distributed inference, lightweight model inference on devices (edge AI), and biometric sensor integration, thereby achieving improvements in computer technology itself (computational efficiency, enhanced user adaptability, improved data management), and attaining technical advancement distinct from mere business process automation or operational efficiency improvement.

The analysis unit can refer to a user's past message history when analyzing the content of a text message to improve analysis accuracy. For example, the analysis unit refers to the user's past message history. The analysis unit uses generative AI to understand past message history and improve the accuracy of text message analysis. For instance, the analysis unit analyzes patterns of messages previously sent by the user and generates similar replies. The analysis unit can also extract specific keywords from the user's past message history and generate appropriate replies. The analysis unit applies algorithms for adjusting the tone and style of replies based on past message history using generative AI. For example, the analysis unit analyzes the user's past message history and generates appropriate replies. By referring to the user's past message history, the accuracy of text message analysis is improved. Specifically, the analysis unit collects the user's past message history data (e.g., sent/received message body, sending time, reply destination, conversation ID, tone labels) as time-series vectors (e.g., N entries×F features, N: number of history entries, F: number of features) and normalizes, tokenizes, and extracts features in a preprocessing unit. Example inputs include histories such as “2024 Jun. 10 09:00 ‘Good morning. I look forward to working with you today.’”, “2024 Jun. 10 12:00 ‘I have sent the meeting materials. Please check them.’”. The analysis unit inputs these history data into a Transformer-based history understanding model or conversation history encoder to extract abstract feature vectors representing past reply patterns, tone, frequent keywords, and reply tendencies. The analysis unit integrates the current input message (e.g., “Please contact me when you finish checking the materials”) with past history feature vectors and inputs them into a reply generation AI model (e.g., large language model). The model dynamically controls parameters such as reply style and tone (e.g., politeness, casualness, information amount) to generate replies reflecting the user's consistency and individuality. Example outputs include “Thank you for checking. I look forward to working with you.” and “Understood. Please contact me if you need anything.”. The analysis unit accumulates user feedback (e.g., adoption, modification, or regeneration instructions for replies) as learning data and updates parameters of the history understanding model and reply generation model via online learning. In subsequent processing, the generated reply text is passed to the UI display unit or speech synthesis unit and presented to the user. Technical effects include enabling highly accurate and highly efficient automatic replies adapted to the user's past conversation history, which are difficult to achieve with conventional template or rule-based replies, thereby improving communication consistency, user satisfaction, and operational efficiency. Application fields include business emails, customer support, SNS chat, FAQ responses, IoT device notification responses, and more. Furthermore, the analysis unit can be implemented in various forms such as collaboration among multiple AI models (e.g., history understanding model+reply generation model+tone estimation model), cloud distributed inference, lightweight model inference on devices (edge AI), and history database integration, thereby achieving improvements in computer technology itself (computational efficiency, enhanced user adaptability, improved data management), and attaining technical advancement distinct from mere business process automation or operational efficiency improvement.

The analysis unit can consider a user's current situation and context when analyzing the content of a text message. For example, the analysis unit considers the user's current situation and context. The analysis unit uses generative AI to understand the current situation and context and analyze the text message. For instance, if the user is in a meeting, the analysis unit generates a short and concise reply. If the user is traveling, the analysis unit can generate a reply including travel-related information. The analysis unit applies algorithms for generating replies considering the user's current situation and context using generative AI. For example, the analysis unit considers the user's current location and activity to generate an appropriate reply. By considering the user's current situation and context, more appropriate replies are generated. Specifically, the analysis unit collects the user's current situation and context information (e.g., current location, activity status, device usage status, calendar appointments, ambient noise level, device connection status) as structured vectors (e.g., F features) and normalizes and categorizes them in a preprocessing unit. Example inputs include “Current location: Meeting Room A”, “Activity: In meeting”, “Calendar: 10:00-11:00 Meeting”, “Device: Silent mode ON”, “Ambient noise: High”. The analysis unit integrates these context information with the current input message (e.g., “Where are you now?”, “Do you want to go out for dinner tonight?”) and inputs them into a context understanding AI model (e.g., Transformer-based multimodal model). The model dynamically controls reply generation parameters (e.g., reply length, information amount, tone, topic selection) based on context features and generates optimal replies according to the situation. For example, if in a meeting, “I will contact you later as I am in a meeting.” is generated; if traveling, “I am currently at a travel destination. I will contact you after I return home.” is generated. The analysis unit accumulates user feedback (e.g., adoption, modification, or regeneration instructions for replies) as learning data and updates parameters of the context understanding model and reply generation model via online learning. In subsequent processing, the generated reply text is passed to the UI display unit or speech synthesis unit and presented to the user. Technical effects include enabling highly accurate and highly efficient automatic replies adapted to the user's current situation and context, which are difficult to achieve with conventional template or rule-based replies, thereby improving communication timeliness, user satisfaction, and operational efficiency. Application fields include business emails, customer support, SNS chat, IoT device notification responses, assistive communication for people with disabilities, and more. Furthermore, the analysis unit can be implemented in various forms such as collaboration among multiple AI models (e.g., context understanding model+reply generation model+activity recognition model), cloud distributed inference, lightweight model inference on devices (edge AI), and integration with external calendar and location information services, thereby achieving improvements in computer technology itself (computational efficiency, enhanced user adaptability, improved data management), and attaining technical advancement distinct from mere business process automation or operational efficiency improvement.

The analysis unit can estimate a user's emotion and adjust a method of displaying an analysis result based on the estimated emotion. For example, the analysis unit estimates the user's emotion. The analysis unit uses generative AI to understand the user's emotion and adjust a method of displaying an analysis result. For instance, if the user is nervous, the analysis unit provides a simple and highly visible display method. If the user is relaxed, the analysis unit can provide a display method including detailed information. The analysis unit applies algorithms for providing display methods according to the user's emotion using generative AI. For example, the analysis unit provides an appropriate display method based on the user's emotion score. By adjusting a method of displaying an analysis result based on the user's emotion, more appropriate displays are provided. Emotion estimation is realized using, for example, an emotion engine or generative AI with emotion estimation functions. Generative AI may be a text generation AI (e.g., LLM) or a multimodal generative AI, but is not limited thereto. Specifically, the analysis unit collects user input data such as text messages (e.g., “I'm nervous today”, “I was able to relax very much”), voice commands (e.g., audio waveform data, spectrogram images), facial images (e.g., H×W×C RGB images), and biometric sensor data (e.g., heart rate, skin conductance, respiration rate as time-series vectors) as multimodal tensors. The analysis unit normalizes and vectorizes these data in a preprocessing unit and inputs them into an emotion estimation AI model (e.g., BERT-based emotion classification model, multimodal fusion model). Example inputs include texts such as “I've been nervous a lot at work lately”, “I'm very calm today”, or “nervous voice audio”, “smiling face image”. The analysis unit integrates features of text, voice, image, and biometric signals using multi-layer self-attention mechanisms and convolutional layers in the model, and outputs emotion classes (e.g., nervousness, relaxation, joy, sadness) and emotion scores (e.g., nervousness level 0.80, relaxation level 0.15). Example outputs include probability distributions such as “Nervousness: 0.75”, “Relaxation: 0.20”, “Joy: 0.05”. The analysis unit inputs these emotion scores as parameters into a display control AI model (e.g., display parameter optimization model) and dynamically controls display methods (e.g., information amount, color scheme, font size, layout, animation presence). For example, if the nervousness level is high, a simple display such as “display only main information in large font at the center, omit unnecessary decorations and details” is generated; if the relaxation level is high, a rich display such as “add detailed analysis results, graphs, and supplementary explanations” is automatically generated. The analysis unit accumulates user feedback (e.g., display preferences, re-display instructions, requests for detailed display) as learning data and updates parameters of the emotion estimation model and display control model via online learning. In subsequent processing, the generated display layout is passed to the UI display unit and reflected in real time on the user device. Technical effects include enabling highly accurate and highly efficient information display adapted to the user's emotional state, which are difficult to achieve with conventional static UIs or uniform information presentation, thereby reducing user stress, improving information comprehension, and increasing satisfaction. Application fields include smartphone applications, medical and healthcare devices, assistive devices for people with disabilities, educational applications, IoT-connected devices, and more. Furthermore, the analysis unit can be implemented in various forms such as collaboration among multiple AI models (e.g., emotion estimation model+display control model+user adaptation model), cloud distributed inference, lightweight model inference on devices (edge AI), and biometric sensor integration, thereby achieving improvements in computer technology itself (computational efficiency, enhanced user adaptability, improved data management), and attaining technical advancement distinct from mere business process automation or operational efficiency improvement.

The analysis unit can consider a user's geographic location information when analyzing the content of a text message. For example, the analysis unit considers the user's geographic location information. The analysis unit uses generative AI to understand geographic location information and analyze the text message. For instance, if the user is at a specific location, the analysis unit generates a reply including information related to that location. If the user is traveling, the analysis unit can generate a reply including information about the travel destination. The analysis unit applies algorithms for generating replies considering the user's geographic location information using generative AI. For example, the analysis unit considers the user's current location and past visited places to generate an appropriate reply. By considering the user's geographic location information, more appropriate replies are generated. Specifically, the analysis unit collects user input data such as text messages (e.g., “Where are you now?”, “Tell me recommended spots at the location”), geographic location information (e.g., GPS coordinates, location labels, stay history), time information, and movement history as structured vectors (e.g., F features). The analysis unit normalizes and categorizes these data in a preprocessing unit and inputs them into a geographic information-embedded natural language understanding model (e.g., location-embedded Transformer model). Example inputs include “Current location: Chiyoda-ku, Tokyo”, “Past visited places: Osaka, Kyoto”, “Text: What are recommended gourmet spots in Osaka?”. The analysis unit integrates geographic features and text features in the model and inputs them into a reply generation AI model to generate replies adapted to geographic context (e.g., “Recommended restaurants near your current location”, “Sending information about sightseeing spots in Kyoto”). Example outputs include “Recommended restaurants near your current location are XX”, “Sending information about sightseeing spots in Kyoto”. The analysis unit accumulates user feedback (e.g., adoption, modification, or regeneration instructions for reply content) as learning data and updates parameters of the geographic information understanding model and reply generation model via online learning. In subsequent processing, the generated reply text is passed to the UI display unit or speech synthesis unit and presented to the user. Technical effects include enabling highly accurate and highly efficient automatic replies adapted to the user's current location and movement history, which are difficult to achieve with conventional location-unaware reply generation or static templates, thereby improving communication timeliness, user satisfaction, and operational efficiency. Application fields include travel support applications, navigation systems, regional information services, IoT-connected devices, assistive communication for people with disabilities, and more. Furthermore, the analysis unit can be implemented in various forms such as collaboration among multiple AI models (e.g., geographic information understanding model+reply generation model+movement prediction model), cloud distributed inference, lightweight model inference on devices (edge AI), and external map API integration, thereby achieving improvements in computer technology itself (computational efficiency, enhanced user adaptability, improved data management), and attaining technical advancement distinct from mere business process automation or operational efficiency improvement.

The analysis unit can refer to a user's social media activity when analyzing the content of a text message. For example, the analysis unit refers to the user's social media activity. The analysis unit uses generative AI to understand social media activity and analyze the text message. For instance, the analysis unit generates a reply based on content recently posted by the user. The analysis unit can also generate replies reflecting the user's interests and concerns based on social media activity. The analysis unit applies algorithms for generating replies by referring to the user's social media activity using generative AI. For example, the analysis unit considers the user's post content and like history to generate an appropriate reply. By referring to the user's social media activity, more appropriate replies are generated. Specifically, the analysis unit collects user input data such as text messages (e.g., “I saw your recent post”, “What movies do you recommend?”), social media activity data (e.g., post history, like history, comment history, follow relationships, posting time, post genre) as time-series vectors (e.g., N entries×F features). The analysis unit normalizes and categorizes these data in a preprocessing unit and inputs them into a social media activity understanding model (e.g., post history encoder+interest clustering model). Example inputs include “2024 Jun. 10 12:00 Post ‘Watched Movie XX’”, “2024Jun. 11 18:00 Like ‘#Travel’”. The analysis unit extracts abstract feature vectors representing post content, interest clusters, and time-series patterns in the model and inputs them into a reply generation AI model to generate replies adapted to the user's interests and concerns (e.g., “How was the movie you watched recently?”, “Your travel photos are wonderful”). Example outputs include “Sending recommended movie information”, “Introducing gourmet information at your travel destination”. The analysis unit accumulates user feedback (e.g., adoption, modification, or regeneration instructions for reply content) as learning data and updates parameters of the social media activity understanding model and reply generation model via online learning. In subsequent processing, the generated reply text is passed to the UI display unit or speech synthesis unit and presented to the user. Technical effects include enabling highly accurate and highly efficient automatic replies adapted to the user's latest interests and concerns, which are difficult to achieve with conventional social media-unaware reply generation or static templates, thereby improving communication consistency, user satisfaction, and operational efficiency. Application fields include SNS chat, customer support, marketing automation, IoT-connected devices, assistive communication for people with disabilities, and more. Furthermore, the analysis unit can be implemented in various forms such as collaboration among multiple AI models (e.g., post history understanding model+reply generation model+interest estimation model), cloud distributed inference, lightweight model inference on devices (edge AI), and external SNS API integration, thereby achieving improvements in computer technology itself (computational efficiency, enhanced user adaptability, improved data management), and attaining technical advancement distinct from mere business process automation or operational efficiency improvement.

The automation unit can estimate a user's emotion and adjust a method of schedule proposal based on the estimated emotion. For example, the automation unit estimates the user's emotion. The automation unit uses generative AI to understand the user's emotion and adjust a method of schedule proposal. For instance, if the user is feeling stressed, the automation unit proposes a schedule that allows relaxation. If the user is relaxed, the automation unit can propose an efficient schedule. The automation unit applies algorithms for schedule proposal according to the user's emotion using generative AI. For example, the automation unit proposes an appropriate schedule based on the user's emotion score. By adjusting a method of schedule proposal based on the user's emotion, more appropriate schedules are proposed. Emotion estimation is realized using, for example, an emotion engine or generative AI with emotion estimation functions. Generative AI may be a text generation AI (e.g., LLM) or a multimodal generative AI, but is not limited thereto. Specifically, the automation unit collects user input data such as text messages (e.g., “I've been feeling tired lately”, “I'm in a good mood today”), voice commands (e.g., audio waveform data, spectrogram images), facial images (e.g., H×W×C RGB images), and biometric sensor data (e.g., heart rate, skin conductance, respiration rate as time-series vectors) as multimodal tensors. The automation unit normalizes and vectorizes these data in a preprocessing unit and inputs them into an emotion estimation AI model (e.g., BERT-based emotion classification model, multimodal fusion model). Example inputs include texts such as “I've been stressed a lot at work lately”, “I was able to relax very much today”, or “calm voice audio”, “smiling face image”. The automation unit integrates features of text, voice, image, and biometric signals using multi-layer self-attention mechanisms and convolutional layers in the model, and outputs emotion classes (e.g., stress, relaxation, joy, sadness) and emotion scores (e.g., stress level 0.80, relaxation level 0.15). Example outputs include probability distributions such as “Stress: 0.75”, “Relaxation: 0.20”, “Joy: 0.05”. The automation unit inputs these emotion scores as parameters into a schedule proposal AI model (e.g., reinforcement learning-based scheduler, constraint satisfaction problem solver) and dynamically controls schedule proposal policies (e.g., appointment density, insertion of break times, setting of travel time margins). For example, if the stress level is high, a relaxation-oriented schedule such as “set more break times”, “postpone less important appointments” is generated; if the relaxation level is high, an efficiency-oriented schedule such as “include consecutive work appointments”, “propose efficient appointment order” is automatically generated. The automation unit accumulates user feedback (e.g., adoption, rejection, modification of proposals) as learning data and updates parameters of the emotion estimation model and schedule proposal model via online learning. In subsequent processing, the generated schedule proposals are passed to the UI display unit or notification unit and presented to the user. Technical effects include enabling highly accurate and highly efficient schedule proposals adapted to the user's emotional state, which are difficult to achieve with conventional static scheduling or uniform appointment proposals, thereby reducing user stress, improving satisfaction, and streamlining schedule management. Application fields include schedule management for businesspersons, shift management in medical and nursing care settings, timetable adjustment in educational settings, assistive schedulers for people with disabilities, IoT-linked schedulers, and more. Furthermore, the automation unit can be implemented in various forms such as collaboration among multiple AI models (e.g., emotion estimation model+schedule optimization model+activity recognition model), cloud distributed inference, lightweight model inference on devices (edge AI), and biometric sensor integration, thereby achieving improvements in computer technology itself (computational efficiency, enhanced user adaptability, improved data management), and attaining technical advancement distinct from mere business process automation or operational efficiency improvement.

The automation unit can refer to a user's past schedule history when analyzing a calendar to improve proposal accuracy. For example, the automation unit refers to the user's past schedule history. The automation unit uses generative AI to understand past schedule history and improve the accuracy of schedule proposals. For instance, the automation unit proposes similar schedules based on appointments previously made by the user. The automation unit can also extract specific patterns from the user's past schedule history and propose optimal schedules. The automation unit applies algorithms for schedule proposal based on past schedule history using generative AI. For example, the automation unit analyzes the user's past schedule history and proposes efficient schedules. By referring to the user's past schedule history, the accuracy of schedule proposals is improved. Specifically, the automation unit collects the user's past schedule history data (e.g., appointment titles, start/end times, locations, participants, tags, priorities, execution results, feedback) as time-series vectors (e.g., N entries×F features, N: number of history entries, F: number of features) and normalizes, categorizes, and extracts features in a preprocessing unit. Example inputs include histories such as “2024 Jun. 10 10:00-11:00 Meeting A”, “2024 Jun. 11 13:00-14:00 Client Visit”, “2024 Jun. 12 15:00-16:00 Document Preparation”. The automation unit inputs these history data into a Transformer-based history understanding model or time-series pattern extraction model to extract abstract feature vectors representing past appointment patterns, frequent appointments, priority tendencies, fulfillment rates, and relationships between appointments. The automation unit integrates current calendar information (e.g., new appointment candidates, available time slots, travel constraints) with past history feature vectors and inputs them into a schedule proposal AI model (e.g., reinforcement learning-based scheduler, constraint satisfaction problem solver). The model dynamically controls parameters such as past appointment performance and user adoption tendencies to generate schedule proposals adapted to the user's habits and preferences. Example outputs include “Set Meeting A in the morning”, “Move document preparation to the afternoon”, “Concentrate client visits at the beginning of the week”. The automation unit accumulates user feedback (e.g., adoption, rejection, modification of proposals) as learning data and updates parameters of the history understanding model and schedule proposal model via online learning. In subsequent processing, the generated schedule proposals are passed to the UI display unit or notification unit and presented to the user. Technical effects include enabling highly accurate and highly efficient schedule proposals adapted to the user's past appointment history, which are difficult to achieve with conventional static calendar apps or simple history reference, thereby improving schedule management consistency, user satisfaction, and operational efficiency. Application fields include schedule management for businesspersons, team scheduling, shift management in medical and nursing care settings, timetable adjustment in educational settings, IoT-linked schedulers, and more. Furthermore, the automation unit can be implemented in various forms such as collaboration among multiple AI models (e.g., history understanding model+schedule optimization model+pattern extraction model), cloud distributed inference, lightweight model inference on devices (edge AI), and history database integration, thereby achieving improvements in computer technology itself (computational efficiency, enhanced user adaptability, improved data management), and attaining technical advancement distinct from mere business process automation or operational efficiency improvement.

The automation unit can consider a user's current situation and context when analyzing a calendar to make proposals. For example, the automation unit considers the user's current situation and context. The automation unit uses generative AI to understand the current situation and context and make schedule proposals. For instance, if the user is in a meeting, the automation unit proposes schedules for after the meeting. If the user is traveling, the automation unit can propose travel-related schedules. The automation unit applies algorithms for schedule proposals considering the user's current situation and context using generative AI. For example, the automation unit considers the user's current location and activity to propose an appropriate schedule. By considering the user's current situation and context, more appropriate schedules are proposed. Specifically, the automation unit collects the user's current situation and context information (e.g., current location, activity status, device usage status, calendar appointments, ambient noise level, device connection status, weather, traffic conditions) as structured vectors (e.g., F features) and normalizes and categorizes them in a preprocessing unit. Example inputs include “Current location: Meeting Room A”, “Activity: In meeting”, “Calendar: 10:00-11:00 Meeting”, “Device: Silent mode ON”, “Ambient noise: High”. The automation unit integrates these context information with current calendar information (e.g., appointment candidates, available time slots, travel constraints) and inputs them into a context understanding AI model (e.g., Transformer-based multimodal model). The model dynamically controls schedule proposal parameters (e.g., appointment priority, time slot, travel time margin, break insertion) based on context features and generates optimal schedule proposals according to the situation. For example, if in a meeting, “insert a break after the meeting”, “postpone important appointments” is generated; if traveling, “prioritize local events and sightseeing appointments” is generated. The automation unit accumulates user feedback (e.g., adoption, rejection, modification of proposals) as learning data and updates parameters of the context understanding model and schedule proposal model via online learning. In subsequent processing, the generated schedule proposals are passed to the UI display unit or notification unit and presented to the user. Technical effects include enabling highly accurate and highly efficient schedule proposals adapted to the user's current situation and context, which are difficult to achieve with conventional static calendar apps or uniform appointment proposals, thereby improving schedule management timeliness, user satisfaction, and operational efficiency. Application fields include schedule management for businesspersons, shift management in medical and nursing care settings, timetable adjustment in educational settings, assistive schedulers for people with disabilities, IoT-linked schedulers, and more. Furthermore, the automation unit can be implemented in various forms such as collaboration among multiple AI models (e.g., context understanding model+schedule optimization model+activity recognition model), cloud distributed inference, lightweight model inference on devices (edge AI), and integration with external calendar and location information services, thereby achieving improvements in computer technology itself (computational efficiency, enhanced user adaptability, improved data management), and attaining technical advancement distinct from mere business process automation or operational efficiency improvement.

The automation unit can estimate a user's emotion and determine the priority of schedule proposals based on the estimated emotion. For example, the automation unit estimates the user's emotion. The automation unit uses generative AI to understand the user's emotion and determine the priority of schedule proposals. For instance, if the user is feeling stressed, the automation unit prioritizes schedules that allow relaxation. If the user is relaxed, the automation unit may prioritize efficient schedules. The automation unit applies an algorithm using generative AI to determine the priority of schedule proposals according to the user's emotion. For example, the automation unit prioritizes appropriate schedules based on the user's emotion score. By determining the priority of schedule proposals based on the user's emotion, more appropriate schedules can be proposed. Emotion estimation is realized using an emotion engine or generative AI, employing emotion estimation functions. Generative AI may include text generation AI (e.g., LLM) or multimodal generative AI, but is not limited to these examples. Specifically, the automation unit collects user input data such as text messages (e.g., “I am tired today”, “I feel good”), voice commands (e.g., audio waveform data, spectrogram images), facial images (e.g., H×W×C RGB images), and biometric sensor data (e.g., heart rate, skin conductance, respiratory rate, etc. as time-series vectors) as multimodal tensors. The automation unit normalizes and vectorizes these data in a preprocessing unit and inputs them into an AI model for emotion estimation (e.g., BERT-based emotion classification model, multimodal fusion model). Examples of input include text such as “I've been stressed lately”, “I was able to relax today”, or audio such as “calm voice”, or facial images such as “smiling face”. Within the model, the automation unit integrates features of text, audio, images, and biometric signals using multi-layer self-attention mechanisms and convolutional layers, and outputs emotion classes (e.g., stress, relaxation, joy, sadness, etc.) and emotion scores (e.g., stress level 0.80, relaxation level 0.15, etc.). Example outputs include probability distributions such as “stress: 0.75”, “relaxation: 0.20”, “joy: 0.05”. The automation unit inputs these emotion scores as parameters into an AI model for schedule proposal (e.g., reinforcement learning-based scheduler, constraint satisfaction problem solver, etc.) and dynamically controls the priority of schedule proposals (e.g., prioritizing break schedules, postponing low-importance schedules, advancing efficiency-focused schedules, etc.). For example, if the stress level is high, the system automatically generates priorities such as “prioritize relaxing schedules and breaks” and “postpone low-importance schedules”; if the relaxation level is high, “prioritize efficient work schedules”. The automation unit accumulates user feedback (e.g., adoption, rejection, modification of proposals) as learning data and updates the parameters of the emotion estimation model and schedule proposal model through online learning. Subsequently, the generated schedule proposals are passed to the UI display unit or notification unit and presented to the user. As a technical effect, high-precision and high-efficiency schedule prioritization adapted to the user's emotional state, which is difficult to achieve with conventional static scheduling or uniform schedule proposals, becomes possible, resulting in reduced user stress, improved satisfaction, and more efficient schedule management. Application fields include schedule management for business persons, shift management in medical and nursing care settings, timetable adjustment in educational settings, schedulers for supporting persons with disabilities, and IoT-linked schedulers. Furthermore, the automation unit can implement various configurations such as cooperation among multiple AI models (e.g., emotion estimation model+schedule optimization model+activity recognition model), cloud distributed inference, lightweight model inference on devices (edge AI), and biometric sensor integration. Through these configurations, the automation unit achieves improvements in computer technology itself (computational efficiency, enhanced user adaptability, improved data management), attaining technical advances distinct from mere business process automation or operational efficiency.

The automation unit can make proposals by considering the user's geographic location information when analyzing the calendar. For example, the automation unit considers the user's geographic location information. The automation unit uses generative AI to understand geographic location information and make schedule proposals. For instance, if the user is at a specific location, the automation unit proposes schedules related to that location. If the user is traveling, the automation unit can also propose schedules for the travel destination. The automation unit applies an algorithm using generative AI to make schedule proposals considering the user's geographic location information. For example, the automation unit proposes appropriate schedules by considering the user's current location and past visited places. By considering the user's geographic location information, more appropriate schedules can be proposed. Specifically, the automation unit collects user input data such as calendar events (e.g., event title, start/end time, location, participants, etc.), geographic location information (e.g., GPS coordinates, location labels, stay history), time information, and movement history as structured vectors (e.g., F features). The automation unit normalizes and categorizes these data in a preprocessing unit and inputs them into a schedule proposal model with geographic information (e.g., Transformer model with location embeddings). Examples of input include “current location: Chiyoda-ku, Tokyo”, “past visited places: Osaka, Kyoto”, “event: meeting in Osaka”, etc. Within the model, the automation unit integrates geographic features and event features and inputs them into the schedule proposal AI model to generate schedule proposals adapted to the geographic context (e.g., “prioritize events near the current location”, “order events considering travel time”, “propose events at travel destinations”, etc.). Example outputs include “schedule meetings near the current location in the morning”, “insert sightseeing plans in Kyoto in the afternoon”, etc. The automation unit accumulates user feedback (e.g., adoption, modification, regeneration instructions for proposals) as learning data and updates the parameters of the geographic information understanding model and schedule proposal model through online learning. Subsequently, the generated schedule proposals are passed to the UI display unit or notification unit and presented to the user. As a technical effect, high-precision and high-efficiency schedule proposals adapted to the user's current location and movement history, which are difficult to achieve with conventional location-unaware schedule proposals or static templates, become possible, resulting in improved timeliness of schedule management, increased user satisfaction, and enhanced work efficiency. Application fields include travel support apps, navigation systems, regional information services, IoT-linked schedulers, and schedulers for supporting persons with disabilities. Furthermore, the automation unit can implement various configurations such as cooperation among multiple AI models (e.g., geographic information understanding model+schedule optimization model+movement prediction model), cloud distributed inference, lightweight model inference on devices (edge AI), and external map API integration. Through these configurations, the automation unit achieves improvements in computer technology itself (computational efficiency, enhanced user adaptability, improved data management), attaining technical advances distinct from mere business process automation or operational efficiency.

The automation unit can make proposals by referring to the user's social media activity when analyzing the calendar. For example, the automation unit refers to the user's social media activity. The automation unit uses generative AI to understand social media activity and make schedule proposals. For instance, the automation unit proposes related schedules based on the user's recent posts. The automation unit can also propose schedules that reflect the user's interests and preferences derived from social media activity. The automation unit applies an algorithm using generative AI to make schedule proposals by referring to the user's social media activity. For example, the automation unit proposes appropriate schedules by considering the user's post content and like history. By referring to the user's social media activity, more appropriate schedules can be proposed. Specifically, the automation unit collects user input data such as calendar events (e.g., event title, start/end time, location, etc.), social media activity data (e.g., post history, like history, comment history, follow relationships, post time, post genre, etc.) as time-series vectors (e.g., N items×F features). The automation unit normalizes and categorizes these data in a preprocessing unit and inputs them into a social media activity understanding model (e.g., post history encoder+interest clustering model). Examples of input include “2024 Jun. 10 12:00 post ‘Watched movie XX’”, “2024 Jun. 11 18:00 like ‘#travel’”, etc. Within the model, the automation unit extracts abstract feature vectors of post content, interest clusters, and time-series patterns, integrates them with calendar event information, and inputs them into the schedule proposal AI model to generate schedule proposals adapted to the user's interests and preferences (e.g., “propose movie viewing schedule”, “insert travel-related events”, etc.). Example outputs include “propose recommended movie events for the weekend”, “add sightseeing plans at travel destinations”, etc. The automation unit accumulates user feedback (e.g., adoption, modification, regeneration instructions for proposals) as learning data and updates the parameters of the social media activity understanding model and schedule proposal model through online learning. Subsequently, the generated schedule proposals are passed to the UI display unit or notification unit and presented to the user. As a technical effect, high-precision and high-efficiency schedule proposals adapted to the user's latest interests and preferences, which are difficult to achieve with conventional social media-unaware schedule proposals or static templates, become possible, resulting in improved consistency of schedule management, increased user satisfaction, and enhanced work efficiency. Application fields include SNS-linked schedulers, customer support, marketing automation, IoT-linked schedulers, and schedulers for supporting persons with disabilities. Furthermore, the automation unit can implement various configurations such as cooperation among multiple AI models (e.g., post history understanding model+schedule optimization model+interest estimation model), cloud distributed inference, lightweight model inference on devices (edge AI), and external SNS API integration. Through these configurations, the automation unit achieves improvements in computer technology itself (computational efficiency, enhanced user adaptability, improved data management), attaining technical advances distinct from mere business process automation or operational efficiency.

The learning unit can estimate a user's emotion and select learning data based on the estimated emotion. For example, the learning unit estimates the user's emotion. The learning unit uses generative AI to understand the user's emotion and select learning data. For instance, if the user is feeling stressed, the learning unit prioritizes learning data that promotes relaxation. If the user is relaxed, the learning unit may prioritize efficient data for learning. The learning unit applies an algorithm using generative AI to select learning data according to the user's emotion. For example, the learning unit selects appropriate data based on the user's emotion score. By selecting learning data based on the user's emotion, more appropriate data can be learned. Emotion estimation is realized using an emotion engine or generative AI, employing emotion estimation functions. Generative AI may include text generation AI (e.g., LLM) or multimodal generative AI, but is not limited to these examples. Specifically, the learning unit collects user input data such as text messages (e.g., “I'm tired today”, “Work went well”), voice commands (e.g., audio waveform data, spectrogram images), facial images (e.g., H×W×C RGB images), and biometric sensor data (e.g., heart rate, skin conductance, respiratory rate, etc. as time-series vectors) as multimodal tensors. The learning unit normalizes and vectorizes these data in a preprocessing unit and inputs them into an AI model for emotion estimation (e.g., BERT-based emotion classification model, multimodal fusion model). Examples of input include text such as “I've been stressed lately”, “I was able to relax today”, or audio such as “calm voice”, or facial images such as “smiling face”. Within the model, the learning unit integrates features of text, audio, images, and biometric signals using multi-layer self-attention mechanisms and convolutional layers, and outputs emotion classes (e.g., stress, relaxation, joy, sadness, etc.) and emotion scores (e.g., stress level 0.80, relaxation level 0.15, etc.). Example outputs include probability distributions such as “stress: 0.75”, “relaxation: 0.20”, “joy: 0.05”. The learning unit inputs these emotion scores as parameters into a learning data selection algorithm (e.g., sample weighting, data filtering, clustering, etc.), and if the stress level is high, it preferentially learns data with a high relaxation effect (e.g., positive conversation history, healing content, etc.), and if the relaxation level is high, it preferentially learns efficiency-focused data (e.g., operation history for business efficiency, data that yields results in a short time, etc.). The learning unit inputs the selection results into supervised learning or reinforcement learning algorithms (e.g., DQN, PPO, etc.) and sequentially updates model parameters. The learning unit receives user feedback (e.g., satisfaction with learning results, instructions for relearning, etc.) as reward signals and optimizes the parameters of the learning data selection algorithm and emotion estimation model through online learning. Subsequently, the selected learning data is supplied to other AI modules (e.g., operation recommendation model, schedule optimization model, etc.), improving the adaptability of the entire system. As a technical effect, high-precision and high-efficiency learning data selection adapted to the user's emotional state, which is difficult to achieve with conventional uniform data learning or static sampling, becomes possible, resulting in improved learning efficiency, increased model personalization, and enhanced user satisfaction. Application fields include personalized AI assistants, healthcare support, educational apps, support systems for persons with disabilities, and IoT-linked learning platforms. Furthermore, the learning unit can implement various configurations such as cooperation among multiple AI models (e.g., emotion estimation model+data selection model+learning optimization model), cloud distributed learning, lightweight model inference on devices (edge AI), and biometric sensor integration. Through these configurations, the learning unit achieves improvements in computer technology itself (computational efficiency, enhanced user adaptability, improved data management), attaining technical advances distinct from mere business process automation or operational efficiency.

The learning unit can optimize the learning algorithm by referring to past learning data during learning. For example, the learning unit refers to past learning data. The learning unit uses generative AI to understand past learning data and optimize the learning algorithm. For instance, the learning unit selects the optimal learning algorithm based on past learning data. The learning unit can also extract specific patterns from past learning data and adjust the learning algorithm. The learning unit applies an algorithm using generative AI to optimize the learning algorithm based on past learning data. For example, the learning unit analyzes past learning data and applies efficient learning algorithms. By referring to past learning data, the accuracy of the learning algorithm is improved. Specifically, the learning unit collects past learning data (e.g., learning samples, loss value history, weight update history, learning rate changes, batch size, number of epochs, model architecture, evaluation metrics, etc.) as time-series vectors (e.g., N items×F features) and performs normalization and feature extraction in a preprocessing unit. Examples of input include history such as “2024 Jun. 10 learning dataset A, loss value 0.12, accuracy 92%”, “2024 Jun. 11 learning dataset B, loss value 0.09, accuracy 94%”, etc. The learning unit inputs these history data into a history understanding model (e.g., LSTM-based time-series pattern extraction model, Transformer-based history encoder) and extracts abstract feature vectors such as past learning patterns, hyperparameter optimization trends, and model convergence characteristics. Based on the extracted feature vectors, the learning unit inputs them into a learning algorithm selection module (e.g., AutoML algorithm, Bayesian optimization, evolutionary algorithm, etc.) and automatically selects and applies the optimal learning algorithm (e.g., SGD, Adam, RMSprop, learning rate scheduler, data augmentation methods, etc.). The learning unit also monitors new loss values and accuracy metrics obtained during learning and provides online optimization functions to dynamically adjust algorithm parameters (e.g., learning rate, batch size, regularization coefficient, etc.). The learning unit receives user feedback (e.g., satisfaction with learning results, instructions for relearning, etc.) and external evaluation metrics as reward signals and optimizes the parameters of the algorithm selection module and history understanding model through online learning. Subsequently, the optimized learning algorithm is applied to other AI modules (e.g., operation recommendation model, schedule optimization model, etc.), improving the learning efficiency and accuracy of the entire system. As a technical effect, high-precision and high-efficiency learning algorithm optimization based on past learning history, which is difficult to achieve with conventional static algorithm selection or manual parameter adjustment, becomes possible, resulting in reduced learning time, improved model accuracy, and effective utilization of computational resources. Application fields include personalized AI assistants, healthcare support, educational apps, support systems for persons with disabilities, and IoT-linked learning platforms. Furthermore, the learning unit can implement various configurations such as cooperation among multiple AI models (e.g., history understanding model+algorithm selection model+hyperparameter optimization model), cloud distributed learning, and lightweight model inference on devices (edge AI). Through these configurations, the learning unit achieves improvements in computer technology itself (computational efficiency, enhanced user adaptability, improved data management), attaining technical advances distinct from mere business process automation or operational efficiency.

The learning unit can improve learning accuracy by analyzing a user's operation history during learning. For example, the learning unit analyzes the user's operation history. The learning unit uses generative AI to understand the operation history and improve learning accuracy. For instance, the learning unit selects optimal learning data based on the user's operation history. The learning unit can also extract specific patterns from the user's operation history to improve learning accuracy. The learning unit applies an algorithm using generative AI to improve learning accuracy based on the operation history. For example, the learning unit analyzes the user's operation history and applies efficient learning methods. By analyzing the user's operation history, learning accuracy is improved. Specifically, the learning unit collects user operation history data (e.g., application launch events, touch events, setting changes, notification responses, voice commands, etc.) as time-series tensors (e.g., N×T×F, where N is the number of events, T is the time step, F is the number of features) and performs normalization and vectorization in a preprocessing unit. Examples of input include event sequences such as “2024 Jun. 10 08:00 App A launched”, “2024 Jun. 10 08:05 Setting B changed”, “2024 Jun. 10 08:10 App C launched”, etc. The learning unit inputs these high-dimensional data into a feature extraction unit using CNN or Transformer-based encoders to generate abstract feature vectors. The learning unit inputs the extracted feature vectors into supervised learning or reinforcement learning algorithms (e.g., DQN, PPO, etc.) and learns operation frequency distributions and patterns for each user as model parameters. The learning unit extracts frequent patterns and abnormal operations from the operation history and dynamically adjusts the sampling ratio and weighting of learning data to improve learning accuracy. The learning unit receives new user operations and feedback (e.g., change of display order, instruction to hide apps, etc.) as reward signals and updates model parameters through online learning. Subsequently, the learning results are passed to other AI modules (e.g., operation recommendation model, optimization unit, etc.), improving the adaptability and accuracy of the entire system. As a technical effect, high-efficiency and high-precision learning optimized for each user, which is difficult to achieve with conventional static learning or simple history-based recommendations, becomes possible, resulting in reduced operation time, lower error rates, and increased user satisfaction. Application fields include consumer smartphones, business terminals, support devices for persons with disabilities, and IoT-linked devices. Furthermore, the learning unit can implement various configurations such as cooperation among multiple AI models (e.g., operation frequency prediction model+abnormal operation detection model), cloud distributed learning, and lightweight model inference on devices (edge AI). Through these configurations, the learning unit achieves improvements in computer technology itself (computational efficiency, improved data management, enhanced user adaptability), attaining technical advances distinct from mere business process automation or operational efficiency.

The learning unit can estimate a user's emotion and adjust the frequency of learning based on the estimated emotion. For example, the learning unit estimates the user's emotion. The learning unit uses generative AI to understand the user's emotion and adjust the frequency of learning. For instance, if the user is feeling stressed, the learning unit reduces the frequency of learning. If the user is relaxed, the learning unit may increase the frequency of learning. The learning unit applies an algorithm using generative AI to adjust the frequency of learning according to the user's emotion. For example, the learning unit sets an appropriate learning frequency based on the user's emotion score. By adjusting the frequency of learning based on the user's emotion, more appropriate learning is performed. Emotion estimation is realized using an emotion engine or generative AI, employing emotion estimation functions. Generative AI may include text generation AI (e.g., LLM) or multimodal generative AI, but is not limited to these examples. Specifically, the learning unit collects user input data such as text messages (e.g., “I'm tired today”, “Work went well”), voice commands (e.g., audio waveform data, spectrogram images), facial images (e.g., H×W×C RGB images), and biometric sensor data (e.g., heart rate, skin conductance, respiratory rate, etc. as time-series vectors) as multimodal tensors. The learning unit normalizes and vectorizes these data in a preprocessing unit and inputs them into an AI model for emotion estimation (e.g., BERT-based emotion classification model, multimodal fusion model). Examples of input include text such as “I've been stressed lately”, “I was able to relax today”, or audio such as “calm voice”, or facial images such as “smiling face”. Within the model, the learning unit integrates features of text, audio, images, and biometric signals using multi-layer self-attention mechanisms and convolutional layers, and outputs emotion classes (e.g., stress, relaxation, joy, sadness, etc.) and emotion scores (e.g., stress level 0.80, relaxation level 0.15, etc.). Example outputs include probability distributions such as “stress: 0.75”, “relaxation: 0.20”, “joy: 0.05”. The learning unit inputs these emotion scores as parameters into a learning frequency control algorithm (e.g., scheduler, trigger-based learning, batch learning interval adjustment, etc.), and if the stress level is high, it reduces the learning frequency, and if the relaxation level is high, it increases the learning frequency. The learning unit monitors user feedback (e.g., satisfaction with learning results, instructions for relearning, etc.) and system load status, and optimizes the parameters of the learning frequency control algorithm and emotion estimation model through online learning. Subsequently, the adjusted learning frequency is reflected in other AI modules (e.g., operation recommendation model, schedule optimization model, etc.), improving the adaptability and user experience of the entire system. As a technical effect, high-precision and high-efficiency learning frequency control adapted to the user's emotional state, which is difficult to achieve with conventional uniform learning frequency or static scheduling, becomes possible, resulting in improved learning efficiency, increased model personalization, and enhanced user satisfaction. Application fields include personalized AI assistants, healthcare support, educational apps, support systems for persons with disabilities, and IoT-linked learning platforms. Furthermore, the learning unit can implement various configurations such as cooperation among multiple AI models (e.g., emotion estimation model+learning frequency control model+learning optimization model), cloud distributed learning, lightweight model inference on devices (edge AI), and biometric sensor integration. Through these configurations, the learning unit achieves improvements in computer technology itself (computational efficiency, enhanced user adaptability, improved data management), attaining technical advances distinct from mere business process automation or operational efficiency.

The learning unit can select learning data by considering the user's geographic location information during learning. For example, the learning unit considers the user's geographic location information. The learning unit uses generative AI to understand geographic location information and select learning data. For instance, if the user is at a specific location, the learning unit prioritizes learning data related to that location. If the user is traveling, the learning unit can also prioritize learning data related to the travel destination. The learning unit applies an algorithm using generative AI to select learning data considering the user's geographic location information. For example, the learning unit selects appropriate data by considering the user's current location and past visited places. By considering the user's geographic location information, more appropriate data can be learned. Specifically, the learning unit collects user input data such as geographic location information (e.g., GPS coordinates, location labels, stay history), time information, movement history, and text messages (e.g., “Tell me recommended spots in the area”, etc.) as structured vectors (e.g., F features). The learning unit normalizes and categorizes these data in a preprocessing unit and inputs them into a learning data selection model with geographic information (e.g., Transformer model with location embeddings). Examples of input include “current location: Chiyoda-ku, Tokyo”, “past visited places: Osaka, Kyoto”, “text: What are recommended foods in Osaka?”, etc. Within the model, the learning unit integrates geographic features and text features and inputs them into a learning data selection algorithm (e.g., geographic clustering, sample weighting, etc.) to preferentially select learning data adapted to the geographic context (e.g., user behavior history near the current location, operation patterns at travel destinations, etc.). The learning unit inputs the selection results into supervised learning or reinforcement learning algorithms (e.g., DQN, PPO, etc.) and sequentially updates model parameters. The learning unit receives user feedback (e.g., satisfaction with learning results, instructions for relearning, etc.) as reward signals and optimizes the parameters of the geographic information understanding model and learning data selection algorithm through online learning. Subsequently, the selected learning data is supplied to other AI modules (e.g., operation recommendation model, schedule optimization model, etc.), improving the adaptability of the entire system. As a technical effect, high-precision and high-efficiency learning data selection adapted to the user's current location and movement history, which is difficult to achieve with conventional location-unaware learning or static sampling, becomes possible, resulting in improved learning efficiency, increased model personalization, and enhanced user satisfaction. Application fields include travel support apps, navigation systems, regional information services, IoT-linked learning platforms, and support systems for persons with disabilities. Furthermore, the learning unit can implement various configurations such as cooperation among multiple AI models (e.g., geographic information understanding model+data selection model+learning optimization model), cloud distributed learning, lightweight model inference on devices (edge AI), and external map API integration. Through these configurations, the learning unit achieves improvements in computer technology itself (computational efficiency, enhanced user adaptability, improved data management), attaining technical advances distinct from mere business process automation or operational efficiency.

The learning unit can select learning data by referring to the user's social media activity during learning. For example, the learning unit refers to the user's social media activity. The learning unit uses generative AI to understand social media activity and select learning data. For instance, the learning unit prioritizes learning data related to the user's recent posts. The learning unit can also prioritize learning data that reflects the user's interests and preferences derived from social media activity. The learning unit applies an algorithm using generative AI to select learning data by referring to the user's social media activity. For example, the learning unit selects appropriate data by considering the user's post content and like history. By referring to the user's social media activity, more appropriate data can be learned. Specifically, the learning unit collects user input data such as social media activity data (e.g., post history, like history, comment history, follow relationships, post time, post genre, etc.), text messages (e.g., “I saw your recent post”, “What is your recommended movie?”, etc.) as time-series vectors (e.g., N items×F features). The learning unit normalizes and categorizes these data in a preprocessing unit and inputs them into a social media activity understanding model (e.g., post history encoder+interest clustering model). Examples of input include “2024 Jun. 10 12:00 post ‘Watched movie XX’”, “2024 Jun. 11 18:00 like ‘#travel’”, etc. Within the model, the learning unit extracts abstract feature vectors of post content, interest clusters, and time-series patterns, and inputs them into a learning data selection algorithm (e.g., interest clustering, sample weighting, etc.) to preferentially select learning data adapted to the user's interests and preferences (e.g., operation history for genres recently of interest, data related to post content, etc.). The learning unit inputs the selection results into supervised learning or reinforcement learning algorithms (e.g., DQN, PPO, etc.) and sequentially updates model parameters. The learning unit receives user feedback (e.g., satisfaction with learning results, instructions for relearning, etc.) as reward signals and optimizes the parameters of the social media activity understanding model and learning data selection algorithm through online learning. Subsequently, the selected learning data is supplied to other AI modules (e.g., operation recommendation model, schedule optimization model, etc.), improving the adaptability of the entire system. As a technical effect, high-precision and high-efficiency learning data selection adapted to the user's latest interests and preferences, which is difficult to achieve with conventional social media-unaware learning or static sampling, becomes possible, resulting in improved learning efficiency, increased model personalization, and enhanced user satisfaction. Application fields include SNS-linked learning platforms, customer support, marketing automation, IoT-linked learning platforms, and support systems for persons with disabilities. Furthermore, the learning unit can implement various configurations such as cooperation among multiple AI models (e.g., post history understanding model+data selection model+learning optimization model), cloud distributed learning, lightweight model inference on devices (edge AI), and external SNS API integration. Through these configurations, the learning unit achieves improvements in computer technology itself (computational efficiency, enhanced user adaptability, improved data management), attaining technical advances distinct from mere business process automation or operational efficiency.

The optimization unit can estimate a user's emotion and adjust application settings and layouts based on the estimated emotion. For example, the optimization unit estimates the user's emotion. The optimization unit uses generative AI to understand the user's emotion and adjust application settings and layouts. For instance, if the user is feeling stressed, the optimization unit provides a simple and highly visible layout. If the user is relaxed, the optimization unit may provide a layout with detailed information. The optimization unit applies an algorithm using generative AI to provide settings and layouts according to the user's emotion. For example, the optimization unit provides appropriate settings and layouts based on the user's emotion score. By adjusting application settings and layouts based on the user's emotion, a more suitable operating environment is provided. Emotion estimation is realized using an emotion engine or generative AI, employing emotion estimation functions. Generative AI may include text generation AI (e.g., LLM) or multimodal generative AI, but is not limited to these examples. Specifically, the optimization unit collects user input data such as text messages (e.g., “I'm tired today”, “Work went well”), voice commands (e.g., audio waveform data, spectrogram images), facial images (e.g., H×W×C RGB images), and biometric sensor data (e.g., heart rate, skin conductance, respiratory rate, etc. as time-series vectors) as multimodal tensors. The optimization unit normalizes and vectorizes these data in a preprocessing unit and inputs them into an AI model for emotion estimation (e.g., BERT-based emotion classification model, multimodal fusion model). Examples of input include text such as “I've been stressed lately”, “I was able to relax today”, or audio such as “calm voice”, or facial images such as “smiling face”. Within the model, the optimization unit integrates features of text, audio, images, and biometric signals using multi-layer self-attention mechanisms and convolutional layers, and outputs emotion classes (e.g., stress, relaxation, joy, sadness, etc.) and emotion scores (e.g., stress level 0.80, relaxation level 0.15, etc.). Example outputs include probability distributions such as “stress: 0.75”, “relaxation: 0.20”, “joy: 0.05”. The optimization unit inputs these emotion scores as parameters into an AI model for settings and layout optimization (e.g., display parameter optimization model, UI layout generation model) and dynamically controls setting items (e.g., amount of information, color scheme, font size, layout, animation presence, notification volume, etc.). For example, if the stress level is high, the system automatically generates simple displays such as “display only main information in large letters at the center” and “omit unnecessary decorations and detailed information”; if the relaxation level is high, it automatically generates rich displays such as “add detailed analysis results, graphs, and supplementary explanations”. The optimization unit accumulates user feedback (e.g., preferences for settings and layouts, instructions for resetting, requests for detailed display, etc.) as learning data and updates the parameters of the emotion estimation model and settings/layout optimization model through online learning. Subsequently, the generated settings and layouts are passed to the UI display unit or notification unit and reflected in real time on the user's device. As a technical effect, high-precision and high-efficiency settings and layout optimization adapted to the user's emotional state, which is difficult to achieve with conventional static UIs or uniform settings, becomes possible, resulting in reduced user stress, improved information comprehension, and increased satisfaction. Application fields include smartphone applications, medical and healthcare devices, support devices for persons with disabilities, educational apps, and IoT-linked devices. Furthermore, the optimization unit can implement various configurations such as cooperation among multiple AI models (e.g., emotion estimation model+settings optimization model+user adaptation model), cloud distributed inference, lightweight model inference on devices (edge AI), and biometric sensor integration. Through these configurations, the optimization unit achieves improvements in computer technology itself (computational efficiency, enhanced user adaptability, improved data management), attaining technical advances distinct from mere business process automation or operational efficiency.

The optimization unit can improve optimization accuracy by referring to a user's past operation history during optimization. For example, the optimization unit refers to the user's past operation history. The optimization unit uses generative AI to understand past operation history and improve optimization accuracy. For instance, the optimization unit proposes optimal settings and layouts based on the user's past operation history. The optimization unit can also extract specific patterns from the user's operation history to improve optimization accuracy. The optimization unit applies an algorithm using generative AI to perform optimization based on past operation history. For example, the optimization unit analyzes the user's operation history and applies efficient settings and layouts. By referring to the user's past operation history, optimization accuracy is improved. Specifically, the optimization unit collects user operation history data (e.g., application launch events, touch events, setting changes, notification responses, voice commands, etc.) as time-series tensors (e.g., N×T×F, where N is the number of events, T is the time step, F is the number of features) and performs normalization and vectorization in a preprocessing unit. Examples of input include event sequences such as “2024 Jun. 10 08:00 App A launched”, “2024 Jun. 10 08:05 Setting B changed”, “2024 Jun. 10 08:10 App C launched”, etc. The optimization unit inputs these high-dimensional data into a feature extraction unit using CNN or Transformer-based encoders to generate abstract feature vectors. The optimization unit inputs the extracted feature vectors into an AI model for settings and layout optimization (e.g., user behavior pattern understanding model+UI optimization model) and learns operation frequency distributions and patterns for each user as model parameters. The optimization unit extracts frequent patterns and abnormal operations from the operation history and dynamically adjusts the sampling ratio and weighting of settings and layouts to improve optimization accuracy. The optimization unit receives new user operations and feedback (e.g., change of display order, instruction to hide apps, etc.) as reward signals and updates model parameters through online learning. Subsequently, the optimization results are passed to the UI display unit or notification unit and reflected in real time on the user's device. As a technical effect, high-efficiency and high-precision settings and layout optimization tailored for each user, which is difficult to achieve with conventional static optimization or simple history-based settings, becomes possible, resulting in reduced operation time, lower error rates, and increased user satisfaction. Application fields include consumer smartphones, business terminals, support devices for persons with disabilities, and IoT-linked devices. Furthermore, the optimization unit can implement various configurations such as cooperation among multiple AI models (e.g., operation frequency prediction model+abnormal operation detection model+UI optimization model), cloud distributed inference, and lightweight model inference on devices (edge AI). Through these configurations, the optimization unit achieves improvements in computer technology itself (computational efficiency, improved data management, enhanced user adaptability), attaining technical advances distinct from mere business process automation or operational efficiency.

The optimization unit can perform optimization by considering the user's current situation and context during optimization. For example, the optimization unit considers the user's current situation and context. The optimization unit uses generative AI to understand the current situation and context and perform optimization. For instance, if the user is in a meeting, the optimization unit provides settings and layouts suitable for meetings. If the user is traveling, the optimization unit can also provide settings and layouts suitable for travel. The optimization unit applies an algorithm using generative AI to perform optimization considering the user's current situation and context. For example, the optimization unit provides appropriate settings and layouts by considering the user's current location and activity. By considering the user's current situation and context, more appropriate settings and layouts can be provided. Specifically, the optimization unit collects information on the user's current situation and context (e.g., current location, activity status, device usage status, calendar events, ambient noise level, device connection status, weather, traffic conditions, etc.) as structured vectors (e.g., F features) and performs normalization and categorization in a preprocessing unit. Examples of input include “current location: Meeting Room A”, “activity: in a meeting”, “calendar: 10:00-11:00 meeting”, “device: silent mode ON”, “ambient noise: high”, etc. The optimization unit integrates these context information with the current application state and user operation history and inputs them into a context understanding AI model (e.g., Transformer-based multimodal model). The model dynamically controls settings and layout optimization parameters (e.g., notification volume, screen brightness, amount of information, layout configuration, etc.) based on context features and generates optimal settings and layouts according to the situation. For example, during a meeting, the system generates settings such as “mute notifications”, “lower screen brightness”, “display only main information”; during travel, “display local information widget”, “prioritize route guidance”, etc. The optimization unit accumulates user feedback (e.g., adoption, modification, reset instructions for settings and layouts, etc.) as learning data and updates the parameters of the context understanding model and settings/layout optimization model through online learning. Subsequently, the generated settings and layouts are passed to the UI display unit or notification unit and reflected in real time on the user's device. As a technical effect, high-precision and high-efficiency settings and layout optimization adapted to the user's current situation and context, which is difficult to achieve with conventional static settings or uniform layouts, becomes possible, resulting in improved timeliness of the operating environment, increased user satisfaction, and enhanced work efficiency. Application fields include business terminals, medical and nursing care work terminals, educational apps, support devices for persons with disabilities, and IoT-linked devices. Furthermore, the optimization unit can implement various configurations such as cooperation among multiple AI models (e.g., context understanding model+settings optimization model+activity recognition model), cloud distributed inference, lightweight model inference on devices (edge AI), and external calendar/location information service integration. Through these configurations, the optimization unit achieves improvements in computer technology itself (computational efficiency, enhanced user adaptability, improved data management), attaining technical advances distinct from mere business process automation or operational efficiency.

The optimization unit can estimate a user's emotion and determine the priority of optimization based on the estimated emotion. For example, the optimization unit estimates the user's emotion. The optimization unit uses generative AI to understand the user's emotion and determine the priority of optimization. For instance, if the user is feeling stressed, the optimization unit prioritizes settings and layouts that allow relaxation. If the user is relaxed, the optimization unit may prioritize efficient settings and layouts. The optimization unit applies an algorithm using generative AI to determine the priority of optimization according to the user's emotion. For example, the optimization unit prioritizes appropriate settings and layouts based on the user's emotion score. By determining the priority of optimization based on the user's emotion, more appropriate settings and layouts can be provided. Emotion estimation is realized using an emotion engine or generative AI, employing emotion estimation functions. Generative AI may include text generation AI (e.g., LLM) or multimodal generative AI, but is not limited to these examples. Specifically, the optimization unit collects user input data such as text messages, voice commands, facial images, and biometric sensor data as multimodal tensors and performs normalization and vectorization in a preprocessing unit. The optimization unit inputs these data into an AI model for emotion estimation (e.g., BERT-based emotion classification model, multimodal fusion model) and outputs emotion classes and emotion scores. Example outputs include probability distributions such as “stress: 0.75”, “relaxation: 0.20”, “joy: 0.05”. The optimization unit inputs these emotion scores as parameters into an optimization priority determination algorithm (e.g., priority scoring, weighted decision-making model, etc.) and dynamically controls the priority of settings and layouts (e.g., relaxation-focused UI, efficiency-focused UI, notification control, information amount adjustment, etc.). For example, if the stress level is high, the system automatically generates priorities such as “prioritize settings and layouts for relaxation”, “suppress notification sounds”, “reduce information amount”; if the relaxation level is high, “prioritize efficient work support UI”, “display detailed information”, etc. The optimization unit accumulates user feedback (e.g., adoption, rejection, modification of settings and layouts) as learning data and updates the parameters of the emotion estimation model and optimization priority determination model through online learning. Subsequently, the generated settings and layouts are passed to the UI display unit or notification unit and reflected in real time on the user's device. As a technical effect, high-precision and high-efficiency optimization priority control adapted to the user's emotional state, which is difficult to achieve with conventional static prioritization or uniform settings, becomes possible, resulting in reduced user stress, increased satisfaction, and optimized operating environment. Application fields include smartphone applications, medical and healthcare devices, support devices for persons with disabilities, educational apps, and IoT-linked devices. Furthermore, the optimization unit can implement various configurations such as cooperation among multiple AI models (e.g., emotion estimation model+priority determination model+UI optimization model), cloud distributed inference, lightweight model inference on devices (edge AI), and biometric sensor integration. Through these configurations, the optimization unit achieves improvements in computer technology itself (computational efficiency, enhanced user adaptability, improved data management), attaining technical advances distinct from mere business process automation or operational efficiency.

The optimization unit can perform optimization by considering the user's geographic location information during optimization. For example, the optimization unit considers the user's geographic location information. The optimization unit uses generative AI to understand geographic location information and perform optimization. For instance, if the user is at a specific location, the optimization unit provides settings and layouts related to that location. If the user is traveling, the optimization unit can also provide settings and layouts suitable for the travel destination. The optimization unit applies an algorithm using generative AI to perform optimization considering the user's geographic location information. For example, the optimization unit provides appropriate settings and layouts by considering the user's current location and past visited places. By considering the user's geographic location information, more appropriate settings and layouts can be provided. Specifically, the optimization unit collects user input data such as geographic location information (e.g., GPS coordinates, location labels, stay history), time information, movement history, application usage status, etc. as structured vectors (e.g., F features). The optimization unit normalizes and categorizes these data in a preprocessing unit and inputs them into a settings and layout optimization model with geographic information (e.g., Transformer model with location embeddings). Examples of input include “current location: Chiyoda-ku, Tokyo”, “past visited places: Osaka, Kyoto”, “application usage: local information app launched”, etc. Within the model, the optimization unit integrates geographic features and application usage features and inputs them into an AI model for settings and layout optimization to generate settings and layouts adapted to the geographic context (e.g., “display local information widget near the current location”, “suppress notification sounds while moving”, “local information layout at travel destination”, etc.). Example outputs include “display weather information near the current location”, “add sightseeing spot widget at travel destination”, etc. The optimization unit accumulates user feedback (e.g., adoption, modification, reset instructions for settings and layouts, etc.) as learning data and updates the parameters of the geographic information understanding model and settings/layout optimization model through online learning. Subsequently, the generated settings and layouts are passed to the UI display unit or notification unit and reflected in real time on the user's device. As a technical effect, high-precision and high-efficiency settings and layout optimization adapted to the user's current location and movement history, which is difficult to achieve with conventional location-unaware settings/layouts or static templates, becomes possible, resulting in improved timeliness of the operating environment, increased user satisfaction, and enhanced work efficiency. Application fields include travel support apps, navigation systems, regional information services, IoT-linked devices, and support devices for persons with disabilities. Furthermore, the optimization unit can implement various configurations such as cooperation among multiple AI models (e.g., geographic information understanding model+settings optimization model+movement prediction model), cloud distributed inference, lightweight model inference on devices (edge AI), and external map API integration. Through these configurations, the optimization unit achieves improvements in computer technology itself (computational efficiency, enhanced user adaptability, improved data management), attaining technical advances distinct from mere business process automation or operational efficiency.

The optimization unit can perform optimization by referring to the user's social media activity during optimization. For example, the optimization unit refers to the user's social media activity. The optimization unit uses generative AI to understand social media activity and perform optimization. For instance, the optimization unit provides settings and layouts related to the user's recent posts. The optimization unit can also provide settings and layouts that reflect the user's interests and preferences derived from social media activity. The optimization unit applies an algorithm using generative AI to perform optimization by referring to the user's social media activity. For example, the optimization unit provides appropriate settings and layouts by considering the user's post content and like history. By referring to the user's social media activity, more appropriate settings and layouts can be provided. Specifically, the optimization unit collects user input data such as social media activity data (e.g., post history, like history, comment history, follow relationships, post time, post genre, etc.), text messages, application usage status, etc. as time-series vectors (e.g., N items×F features). The optimization unit normalizes and categorizes these data in a preprocessing unit and inputs them into a social media activity understanding model (e.g., post history encoder+interest clustering model). Examples of input include “2024 Jun. 10 12:00 post ‘Watched movie XX’”, “2024 Jun. 11 18:00 like ‘#travel’”, etc. Within the model, the optimization unit extracts abstract feature vectors of post content, interest clusters, and time-series patterns, and inputs them into an AI model for settings and layout optimization to generate settings and layouts adapted to the user's interests and preferences (e.g., “display movie-related widget”, “highlight travel genre information”, etc.). Example outputs include “add recommended movie information widget”, “display gourmet information at travel destination”, etc. The optimization unit accumulates user feedback (e.g., adoption, modification, reset instructions for settings and layouts, etc.) as learning data and updates the parameters of the social media activity understanding model and settings/layout optimization model through online learning. Subsequently, the generated settings and layouts are passed to the UI display unit or notification unit and reflected in real time on the user's device. As a technical effect, high-precision and high-efficiency settings and layout optimization adapted to the user's latest interests and preferences, which are difficult to achieve with conventional social media-unaware settings/layouts or static templates, becomes possible, resulting in improved consistency of the operating environment, increased user satisfaction, and enhanced work efficiency. Application fields include SNS-linked applications, customer support, marketing automation, IoT-linked devices, and support devices for persons with disabilities. Furthermore, the optimization unit can implement various configurations such as cooperation among multiple AI models (e.g., post history understanding model+settings optimization model+interest estimation model), cloud distributed inference, lightweight model inference on devices (edge AI), and external SNS API integration. Through these configurations, the optimization unit achieves improvements in computer technology itself (computational efficiency, enhanced user adaptability, improved data management), attaining technical advances distinct from mere business process automation or operational efficiency.

The system according to the embodiment is not limited to the examples described above and can be variously modified, for example, as follows. Specifically, the system can implement various variations regarding AI model architecture, learning methods, data flow, input/output specifications, hardware configuration, and cooperation modules. The system can combine not only inference by a single large language model but also cooperation among multiple AI models (e.g., emotion estimation model+behavior prediction model+UI optimization model), cloud distributed inference, lightweight model inference on devices (edge AI), biometric sensor integration, and external API integration. The system accepts diverse multimodal data as user input, such as text, audio, images, geographic information, operation history, and sensor data, performs normalization, vectorization, and feature extraction in a preprocessing unit, and inputs them into AI models. The AI models can adopt various architectures such as Transformer, CNN, RNN, autoregressive models, and reinforcement learning algorithms, and can select the optimal model according to the application and device performance. The output of the AI models can be flexibly designed according to the application, including score distributions, labels, probability values, structured data, recommendation lists, scripts, UI layouts, notification control parameters, etc. Subsequently, the output results are passed to the UI display unit, notification unit, speech synthesis unit, external cooperation modules, etc., and reflected in real time on user devices or cloud services. Furthermore, the system can accumulate user feedback (e.g., adoption, modification, reset instructions for settings and layouts, satisfaction with learning results, instructions for relearning, etc.) as learning data and optimize AI model parameters through online learning. As a result, the system enables high-precision and high-efficiency automation and optimization adapted to diverse user situations, emotions, interests, and behaviors, which are difficult to achieve with conventional static settings/layouts or single-model inference, and achieves technical effects such as improved user experience, operational efficiency, reduced error rates, improved computational efficiency, and enhanced data management for the entire system. Application fields include smartphone applications, business terminals, medical and healthcare support, educational apps, support devices for persons with disabilities, IoT-linked devices, and cloud service platforms.

The analysis unit can also analyze a user's voice command and automatically generate appropriate operations. For example, when a user says “Tell me my next schedule” by voice, the analysis unit analyzes the calendar and notifies the next schedule by voice. When a user says “Send a message”, the analysis unit converts the message content from voice to text and sends it to the appropriate recipient. Furthermore, when a user says “Tell me the weather”, the analysis unit can acquire weather information and notify it by voice. By analyzing voice commands and automatically generating appropriate operations, user operations are further streamlined. Specifically, the analysis unit collects user input data such as audio waveform data (e.g., PCM data sampled at 16 kHz, T samples in length), spectrogram images of voice commands, utterance time, device state information, etc. as multidimensional tensors. The analysis unit performs noise removal, normalization, and feature extraction (e.g., MFCC, Mel-spectrogram, acoustic feature vectorization) in a preprocessing unit and inputs the audio data into an AI model for speech recognition (e.g., Transformer-based speech recognition model, RNN-CTC model, end-to-end speech understanding model). Examples of input include “audio waveform: ‘Tell me my next schedule’”, “audio waveform: ‘Send a message’”, etc. Within the model, the analysis unit decodes text command sequences (e.g., “Tell me my next schedule”, “Send a message”) from acoustic features and further inputs them into a natural language understanding model (e.g., BERT-based command classification model) to extract command types (e.g., schedule inquiry, message sending, weather inquiry, etc.) and parameters (e.g., recipient, content, date/time, etc.). Example outputs include “command type: schedule inquiry, parameter: next schedule”, “command type: message sending, parameter: content=XX, recipient=YY”, etc. The analysis unit passes the extracted command types and parameters to a subsequent operation auto-generation module, which automatically generates specific operation scripts such as calendar inquiry API calls, message sending API calls, weather information acquisition API calls, etc. The generated operation scripts are passed to the speech synthesis unit or UI display unit and presented to the user as voice notifications or screen displays. As a technical effect, the analysis unit realizes high-precision recognition, semantic understanding, and dynamic operation generation for complex natural language voice commands, which are difficult to achieve with conventional simple voice command mapping or static rule-based processing, and enables automation adapted to diverse user utterance patterns and situations. As a result, users can efficiently execute various device operations by voice alone without manual operation or screen transitions, achieving improved accessibility, operational efficiency, and reduced error rates. Application fields include smartphone voice assistants, in-vehicle infotainment systems, smart home control, support devices for persons with disabilities, and IoT-linked voice operation platforms. Furthermore, the analysis unit can implement various configurations such as cooperation among multiple AI models (e.g., speech recognition model+natural language understanding model+operation generation model), cloud distributed inference, lightweight model inference on devices (edge AI), and external API integration. Through these configurations, the analysis unit achieves improvements in computer technology itself (improved speech recognition accuracy, computational efficiency, enhanced user adaptability, improved data management), attaining technical advances distinct from mere business process automation or operational efficiency.

The analysis unit can also estimate a user's emotion and automatically generate a music playlist based on the estimated emotion. For example, if the user is feeling stressed, the analysis unit selects and plays relaxing music. If the user is in a lively mood, the analysis unit can select and play up-tempo music. Furthermore, if the user is feeling sad, the analysis unit can select and play healing music. By automatically generating a music playlist based on the user's emotion, a more personalized music experience is provided. Specifically, the analysis unit collects user input data such as text messages (e.g., “I'm tired today”, “I want to listen to uplifting songs”), voice commands (e.g., audio waveform data, spectrogram images), facial images (e.g., H×W×C RGB images), and biometric sensor data (e.g., heart rate, skin conductance, respiratory rate, etc. as time-series vectors) as multimodal tensors. The analysis unit normalizes and vectorizes these data in a preprocessing unit and inputs them into an AI model for emotion estimation (e.g., BERT-based emotion classification model, multimodal fusion model). Examples of input include text such as “I'm feeling a bit down today”, “Play uplifting music”, or audio such as “bright voice”, or facial images such as “smiling face”. Within the model, the analysis unit integrates features of text, audio, images, and biometric signals using multi-layer self-attention mechanisms and convolutional layers, and outputs emotion classes (e.g., stress, relaxation, energy, sadness, etc.) and emotion scores (e.g., stress level 0.60, relaxation level 0.30, energy level 0.10, etc.). Example outputs include probability distributions such as “stress: 0.70”, “relaxation: 0.20”, “energy: 0.10”. The analysis unit inputs these emotion scores as parameters into a music playlist auto-generation algorithm (e.g., emotion-labeled music clustering, reinforcement learning-based recommendation model, etc.), and if the stress level is high, it preferentially selects relaxing music (e.g., healing music, classical, etc.), if the energy level is high, up-tempo music (e.g., pop, rock, etc.), and if the sadness level is high, healing music (e.g., ballads, ambient, etc.). Example outputs include “relaxing playlist”, “uplifting song list”, “healing music list”, etc. The analysis unit accumulates user feedback (e.g., skipping, repeating, rating of played songs) as learning data and updates the parameters of the emotion estimation model and music recommendation model through online learning. Subsequently, the generated playlists are passed to the music playback unit or UI display unit and reflected in real time on the user's device. As a technical effect, the analysis unit realizes high-precision and high-efficiency music playlist auto-generation adapted to the user's emotional state, which is difficult to achieve with conventional static music recommendations or simple history-based recommendations, resulting in improved personalization of the music experience, increased satisfaction, reduced stress, and enhanced work efficiency. Application fields include smartphone music apps, healthcare support devices, support devices for persons with disabilities, and IoT-linked music playback systems. Furthermore, the analysis unit can implement various configurations such as cooperation among multiple AI models (e.g., emotion estimation model+music recommendation model+user behavior analysis model), cloud distributed inference, lightweight model inference on devices (edge AI), and external music API integration. Through these configurations, the analysis unit achieves improvements in computer technology itself (improved recommendation accuracy, computational efficiency, enhanced user adaptability, improved data management), attaining technical advances distinct from mere business process automation or operational efficiency.

The automation unit can also analyze a user's exercise data and propose appropriate exercise plans. For example, if the user is using a pedometer, the analysis unit analyzes step count data and proposes additional exercise if the target step count has not been reached. If the user is using a heart rate monitor, the analysis unit analyzes heart rate data and can propose appropriate exercise intensity. Furthermore, if the user is using a weight management app, the analysis unit analyzes weight data and can propose appropriate diet plans. By analyzing exercise data and proposing appropriate exercise plans, health management is streamlined. Specifically, the automation unit collects user input data such as step count data (e.g., daily step count, time-series vectors), heart rate data (e.g., minute-by-minute heart rate, time-series vectors), weight data (e.g., daily weight records, time-series vectors), calories burned, exercise type, exercise duration, meal records, etc. as multidimensional tensors. The automation unit normalizes and extracts features from these data in a preprocessing unit (e.g., moving average, peak detection, rate of change calculation, etc.) and inputs them into an AI model for exercise and health data analysis (e.g., time-series pattern extraction model, LSTM-based exercise prediction model, clustering model, etc.). Examples of input include “2024 Jun. 10 steps: 8000”, “2024 Jun. 10 heart rate: average 85 bpm”, “2024 Jun. 10 weight: 70.5 kg”, etc. Within the model, the automation unit extracts abstract feature vectors such as goal achievement, exercise intensity trends, and weight change patterns from past exercise and health data and inputs them into an AI model for exercise plan proposal (e.g., reinforcement learning-based exercise planner, constraint satisfaction problem solver, etc.). The model automatically generates optimal exercise and diet plans according to the user's health status and goals, such as “propose additional walking if target steps are not reached”, “propose increased exercise intensity if heart rate is low”, “propose diet plan if weight is increasing”, etc. Example outputs include “recommend 2000 more steps of walking today”, “add 10 minutes of jogging to raise heart rate”, “propose a low-calorie dinner menu”, etc. The automation unit accumulates user feedback (e.g., adoption, rejection, modification of proposals) and new exercise and health data as learning data and updates the parameters of the exercise data analysis model and exercise plan proposal model through online learning. Subsequently, the generated exercise and diet plans are passed to the UI display unit or notification unit and reflected in real time on the user's device. As a technical effect, the automation unit realizes high-precision and high-efficiency exercise and health plan auto-generation adapted to diverse user health data, which is difficult to achieve with conventional static exercise proposals or simple goal management, resulting in improved personalization of health management, increased goal achievement rate, and enhanced work efficiency. Application fields include fitness apps, healthcare support devices, support devices for persons with disabilities, and IoT-linked health management systems. Furthermore, the automation unit can implement various configurations such as cooperation among multiple AI models (e.g., exercise data analysis model+exercise plan proposal model+diet plan optimization model), cloud distributed inference, lightweight model inference on devices (edge AI), and external health API integration. Through these configurations, the automation unit achieves improvements in computer technology itself (improved health data analysis accuracy, computational efficiency, enhanced user adaptability, improved data management), attaining technical advances distinct from mere business process automation or operational efficiency.

The automation unit can also estimate a user's emotion and adjust the priority of notifications based on the estimated emotion. For example, if the user is feeling stressed, only important notifications are displayed and other notifications are postponed. If the user is relaxed, all notifications can be displayed. Furthermore, if the user is focused, notifications can be temporarily turned off. By adjusting the priority of notifications based on the user's emotion, more appropriate notification management is provided. Specifically, the automation unit collects user input data such as text messages (e.g., “I'm busy today”, “I want to focus”), voice commands (e.g., audio waveform data), facial images (e.g., H×W×C RGB images), and biometric sensor data (e.g., heart rate, skin conductance, etc.) as multimodal tensors. The automation unit normalizes and vectorizes these data in a preprocessing unit and inputs them into an AI model for emotion estimation (e.g., BERT-based emotion classification model, multimodal fusion model). Examples of input include text such as “I'm stressed today”, “I want to focus now”, or audio such as “calm voice”, or facial images such as “serious facial expression”. Within the model, the automation unit integrates features of text, audio, images, and biometric signals using multi-layer self-attention mechanisms and convolutional layers, and outputs emotion classes (e.g., stress, relaxation, focus, etc.) and emotion scores (e.g., stress level 0.80, relaxation level 0.10, focus level 0.10, etc.). Example outputs include probability distributions such as “stress: 0.85”, “relaxation: 0.10”, “focus: 0.05”. The automation unit inputs these emotion scores as parameters into a notification priority control algorithm (e.g., weighted notification filter, priority scoring model, etc.), and if the stress level is high, it automatically generates notification control policies such as “display only important notifications”, “suppress low-priority notifications”; if the relaxation level is high, “display all notifications”; if the focus level is high, “temporarily turn off notifications”. Example outputs include “notify only importance level A”, “all notifications ON”, “notifications OFF”, etc. The automation unit accumulates user feedback (e.g., adoption, rejection, re-display requests for notifications) and new emotion data as learning data and updates the parameters of the emotion estimation model and notification control model through online learning. Subsequently, the generated notification control policies are passed to the notification unit or UI display unit and reflected in real time on the user's device. As a technical effect, the automation unit realizes high-precision and high-efficiency notification priority control adapted to the user's emotional state, which is difficult to achieve with conventional static notification control or simple priority settings, resulting in reduced user stress, maintained concentration, increased satisfaction, and reduced erroneous notifications. Application fields include smartphone notification management, business terminals, support devices for persons with disabilities, and IoT-linked notification systems. Furthermore, the automation unit can implement various configurations such as cooperation among multiple AI models (e.g., emotion estimation model+notification control model+user behavior analysis model), cloud distributed inference, lightweight model inference on devices (edge AI), and external notification API integration. Through these configurations, the automation unit achieves improvements in computer technology itself (improved notification control accuracy, computational efficiency, enhanced user adaptability, improved data management), attaining technical advances distinct from mere business process automation or operational efficiency.

The learning unit can also learn a user's reading history and recommend appropriate books. For example, it analyzes the genres of books the user has read in the past and recommends new books in the same genre. Additionally, if the user prefers books by a particular author, it can recommend new releases by that author. Furthermore, if the user records their reading time, it can propose suitable reading plans based on the reading time. By learning the user's reading history and recommending appropriate books, the reading experience is enhanced. Specifically, the learning unit collects reading history data (e.g., book titles, authors, genres, completion dates, reading times, ratings, reviews, etc.) as time-series vectors (e.g., N entries×F features) as input data from the user. The learning unit preprocesses these data in a preprocessing unit by normalization, category conversion, and feature extraction (e.g., genre encoding, author clustering, reading frequency calculation, etc.), and inputs them into an AI model for reading history understanding (e.g., Transformer-based history encoder, collaborative filtering model, etc.). Examples of input include “2024 Jun. 10 Book A (Genre: Mystery, Author X, Reading Time 2 h)”, “2024 Jun. 11 Book B (Genre: SF, Author Y, Reading Time 1.5 h)”, and so on. The learning unit extracts abstract feature vectors such as past reading patterns, genre/author preference tendencies, and reading time distributions within the model, and inputs them into an AI model for book recommendation (e.g., reinforcement learning-based recommendation model, ranking learning model, etc.). The model automatically recommends new releases by the same genre or author, trending works in similar genres, and short or long stories suitable for the user's reading time, according to the user's preferences and reading tendencies. Examples of output include “New Book C (Author X, Genre: Mystery)”, “Short Story D (Genre: SF)”, and so on. The learning unit sequentially accumulates user feedback (e.g., adoption, rejection, evaluation of recommended books, etc.) and new reading history as learning data, and updates the parameters of the history understanding model and recommendation model through online learning. As a subsequent process, the generated recommended books and reading plans are passed to the UI display unit or notification unit and reflected in real time on the user's terminal. As a technical effect, the learning unit realizes highly accurate and efficient book recommendation and automatic generation of reading plans adapted to the user's reading tendencies, preferences, and reading time, which are difficult to achieve with conventional static book recommendations or simple history-based recommendations, thereby improving the degree of personalization, satisfaction, and reading efficiency of the reading experience. Applicable fields include e-book applications, educational support systems, assistive devices for people with disabilities, and IoT-linked reading management systems. Furthermore, the learning unit can implement various variations such as cooperation of multiple AI models (e.g., history understanding model+recommendation model +reading plan optimization model), cloud distributed learning, lightweight model inference on the terminal (edge AI), and external book API linkage. With these configurations, the learning unit realizes improvements in computer technology itself (improved recommendation accuracy, computational efficiency, enhanced user adaptability, improved data manageability), achieving technical progress different from mere business efficiency improvement or business process automation.

The optimization unit can also estimate a user's emotion and adjust application notification sounds based on the estimated emotion. For example, if the user is feeling stressed, the notification sound is made quieter. If the user is relaxed, the normal notification sound may be used. Furthermore, if the user is concentrating, the notification sound may be turned off. By adjusting application notification sounds based on the user's emotion, a more comfortable operating environment is provided. Specifically, the optimization unit collects user input data such as text messages (e.g., “I'm tired today”, “I want to concentrate”), voice commands (e.g., voice waveform data), facial images (e.g., H×W×C RGB images), and biometric sensor data (e.g., heart rate, skin conductance, etc.) as multimodal tensors. The optimization unit preprocesses these data in a preprocessing unit by normalization and vectorization, and inputs them into an AI model for emotion estimation (e.g., BERT-based emotion classification model, multimodal fusion model). Examples of input include text such as “I'm very stressed today”, “I want it to be quiet now”, or voice with a calm tone, or facial images with a serious expression. The optimization unit integrates features of text, voice, image, and biometric signals within the model using multi-layer self-attention mechanisms and convolutional layers, and outputs emotion classes (e.g., stress, relaxation, concentration, etc.) and emotion scores (e.g., stress level 0.80, relaxation level 0.10, concentration level 0.10, etc.). Examples of output include probability distributions such as “Stress: 0.85”, “Relaxation: 0.10”, “Concentration: 0.05”. The optimization unit inputs these emotion scores as parameters into a notification sound control algorithm (e.g., weighted volume control model, priority scoring model, etc.), and automatically generates notification sound control policies such as “lower notification volume” or “mute notification sound” when stress level is high, “normal volume” when relaxation level is high, and “notification sound OFF” when concentration level is high. Examples of output include “Notification volume 20%”, “Notification volume 100%”, “Notification sound OFF”, and so on. The optimization unit sequentially accumulates user feedback (e.g., adoption, rejection, reconfiguration requests for notification sounds, etc.) and new emotion data as learning data, and updates the parameters of the emotion estimation model and notification sound control model through online learning. As a subsequent process, the generated notification sound control policy is passed to the notification unit or UI display unit and reflected in real time on the user's terminal. As a technical effect, the optimization unit realizes highly accurate and efficient notification sound control adapted to the user's emotional state, which is difficult to achieve with conventional static notification sound settings or simple volume control, thereby reducing user stress, maintaining concentration, improving satisfaction, and reducing false notification rates. Applicable fields include smartphone notification management, business terminals, assistive devices for people with disabilities, and IoT-linked notification systems. Furthermore, the optimization unit can implement various variations such as cooperation of multiple AI models (e.g., emotion estimation model+notification sound control model+user behavior analysis model), cloud distributed inference, lightweight model inference on the terminal (edge AI), and external notification API linkage. With these configurations, the optimization unit realizes improvements in computer technology itself (improved notification sound control accuracy, computational efficiency, enhanced user adaptability, improved data manageability), achieving technical progress different from mere business efficiency improvement or business process automation.

The automation unit can also analyze a user's driving data and provide appropriate driving advice. For example, if the user frequently applies sudden brakes, the analysis unit analyzes the driving style and suggests smoother braking operations. If the user drives for long periods, it can also suggest taking breaks. Furthermore, if the user drives in a fuel-inefficient manner, it can provide driving advice to improve fuel efficiency. By analyzing the user's driving data and providing appropriate driving advice, safe and efficient driving is achieved. Specifically, the automation unit collects vehicle sensor data (e.g., acceleration, speed, brake pressure, engine RPM, fuel efficiency, driving time, GPS trajectory, etc.) as time-series tensors (e.g., N×T×F, where N is the number of driving sessions, T is the time steps, and F is the number of features) as input data from the user. The automation unit preprocesses these data in a preprocessing unit by normalization and feature extraction (e.g., detection of sudden acceleration/deceleration, calculation of fuel efficiency variation rate, aggregation of driving time, etc.), and inputs them into an AI model for driving data analysis (e.g., LSTM-based driving pattern extraction model, abnormal driving detection model, clustering model, etc.). Examples of input include “2024 Jun. 10 08:00-09:00 acceleration, speed, fuel efficiency data”, “2024 Jun. 11 10:00-12:00 driving time 2 h, 5 sudden brakes”, and so on. The automation unit extracts abstract feature vectors such as driving style (e.g., frequency of sudden braking, tendency for long driving, fuel efficiency, etc.) within the model, and inputs them into an AI model for generating driving advice (e.g., reinforcement learning-based driving advisor, rule-based optimization model, etc.). The model automatically generates driving advice such as “suggest smoothing brake operations” when the frequency of sudden braking is high, “suggest taking breaks” for long driving, and “recommend eco-driving” when fuel efficiency is poor. Examples of output include “Recommend applying brakes earlier next time”, “Insert breaks every 2 hours”, “Avoid sudden acceleration to improve fuel efficiency”, and so on. The automation unit sequentially accumulates user feedback (e.g., adoption, rejection, modification of advice, etc.) and new driving data as learning data, and updates the parameters of the driving data analysis model and advice generation model through online learning. As a subsequent process, the generated driving advice is passed to the UI display unit or speech synthesis unit and reflected in real time on the user's terminal or in-vehicle system. As a technical effect, the automation unit realizes highly accurate and efficient automatic generation of driving advice adapted to the user's driving style and situation, which is difficult to achieve with conventional static driving advice or simple history-based suggestions, thereby supporting safe driving, improving fuel efficiency, reducing fatigue, and lowering accident risk. Applicable fields include in-vehicle driving support systems, commercial vehicle operation management, assistive vehicles for people with disabilities, and IoT-linked driving analysis platforms. Furthermore, the automation unit can implement various variations such as cooperation of multiple AI models (e.g., driving data analysis model+advice generation model+abnormal driving detection model), cloud distributed inference, lightweight model inference on the terminal (edge AI), and external vehicle API linkage. With these configurations, the automation unit realizes improvements in computer technology itself (improved driving data analysis accuracy, computational efficiency, enhanced user adaptability, improved data manageability), achieving technical progress different from mere business efficiency improvement or business process automation.

The analysis unit can also estimate a user's emotion and adjust exercise proposals based on the estimated emotion. For example, if the user is feeling stressed, it proposes relaxing yoga or stretching. If the user is in a lively mood, it can also propose high-intensity exercises. Furthermore, if the user is tired, it can propose light walking or relaxation exercises. By adjusting exercise proposals based on the user's emotion, more effective fitness plans are provided. Specifically, the analysis unit collects user input data such as text messages (e.g., “I'm tired today”, “I want to do energizing exercise”), voice commands (e.g., voice waveform data), facial images (e.g., H×W×C RGB images), and biometric sensor data (e.g., heart rate, skin conductance, etc.) as multimodal tensors. The analysis unit preprocesses these data in a preprocessing unit by normalization and vectorization, and inputs them into an AI model for emotion estimation (e.g., BERT-based emotion classification model, multimodal fusion model). Examples of input include text such as “I'm very stressed today”, “I want to do energizing exercise”, or voice with a calm tone, or facial images with a smile. The analysis unit integrates features of text, voice, image, and biometric signals within the model using multi-layer self-attention mechanisms and convolutional layers, and outputs emotion classes (e.g., stress, energy, fatigue, etc.) and emotion scores (e.g., stress level 0.70, energy level 0.20, fatigue level 0.10, etc.). Examples of output include probability distributions such as “Stress: 0.60”, “Energy: 0.30”, “Fatigue: 0.10”. The analysis unit inputs these emotion scores as parameters into an exercise proposal algorithm (e.g., emotion-labeled exercise clustering, reinforcement learning-based exercise recommendation model, etc.), and automatically generates exercise plans such as “yoga/stretching proposal” when stress level is high, “high-intensity exercise proposal” when energy level is high, and “walking/relaxation proposal” when fatigue level is high. Examples of output include “Recommend 20 minutes of yoga today”, “Recommend 10 minutes of high-intensity training”, “Recommend 30 minutes of walking”, and so on. The analysis unit sequentially accumulates user feedback (e.g., adoption, rejection, modification of proposals, etc.) and new emotion data as learning data, and updates the parameters of the emotion estimation model and exercise proposal model through online learning. As a subsequent process, the generated exercise plans are passed to the UI display unit or notification unit and reflected in real time on the user's terminal. As a technical effect, the analysis unit realizes highly accurate and efficient automatic generation of exercise proposals adapted to the user's emotional state, which is difficult to achieve with conventional static exercise proposals or simple history-based recommendations, thereby improving the degree of personalization, satisfaction, and health maintenance/enhancement of the fitness experience. Applicable fields include fitness applications, healthcare support terminals, assistive devices for people with disabilities, and IoT-linked exercise management systems. Furthermore, the analysis unit can implement various variations such as cooperation of multiple AI models (e.g., emotion estimation model+exercise proposal model+user behavior analysis model), cloud distributed inference, lightweight model inference on the terminal (edge AI), and external exercise API linkage. With these configurations, the analysis unit realizes improvements in computer technology itself (improved proposal accuracy, computational efficiency, enhanced user adaptability, improved data manageability), achieving technical progress different from mere business efficiency improvement or business process automation.

The automation unit can also analyze a user's sleep data and provide appropriate sleep improvement advice. For example, if the user is sleep-deprived, the analysis unit analyzes the sleep data and suggests going to bed earlier. If the user is not getting deep sleep, it can also propose creating a relaxing environment. Furthermore, if the user has irregular sleep patterns, it can propose a regular sleep schedule. By analyzing the user's sleep data and providing appropriate sleep improvement advice, sleep quality is improved. Specifically, the automation unit collects sleep sensor data (e.g., sleep onset time, wake-up time, sleep duration, ratio of deep/light sleep, number of awakenings, heart rate, respiration rate, etc.) as time-series vectors (e.g., N days×F features) as input data from the user. The automation unit preprocesses these data in a preprocessing unit by normalization and feature extraction (e.g., sleep cycle analysis, variation rate calculation, anomaly detection, etc.), and inputs them into an AI model for sleep data analysis (e.g., LSTM-based sleep pattern extraction model, clustering model, etc.). Examples of input include “2024 Jun. 10 sleep onset 23:00, wake-up 6:30, deep sleep 2.5 h”, “2024 Jun. 11 sleep onset 1:00, wake-up 7:00, 3 awakenings”, and so on. The automation unit extracts abstract feature vectors such as sleep deprivation tendency, lack of deep sleep, and irregularity of sleep patterns within the model, and inputs them into an AI model for generating sleep improvement advice (e.g., reinforcement learning-based advice generation model, rule-based optimization model, etc.). The model automatically generates advice such as “suggest going to bed earlier” for sleep deprivation, “suggest creating a relaxing environment” for lack of deep sleep, and “suggest a regular schedule” for irregular sleep patterns. Examples of output include “Recommend going to bed by 23:00 today”, “Recommend dimming bedroom lights”, “Go to bed and wake up at the same time every day”, and so on. The automation unit sequentially accumulates user feedback (e.g., adoption, rejection, modification of advice, etc.) and new sleep data as learning data, and updates the parameters of the sleep data analysis model and advice generation model through online learning. As a subsequent process, the generated sleep improvement advice is passed to the UI display unit or notification unit and reflected in real time on the user's terminal. As a technical effect, the automation unit realizes highly accurate and efficient automatic generation of sleep improvement advice adapted to the user's sleep patterns and state, which is difficult to achieve with conventional static sleep advice or simple history-based suggestions, thereby improving sleep quality, maintaining health, and increasing satisfaction. Applicable fields include sleep management applications, healthcare support terminals, assistive devices for people with disabilities, and IoT-linked sleep management systems. Furthermore, the automation unit can implement various variations such as cooperation of multiple AI models (e.g., sleep data analysis model+advice generation model+abnormal sleep detection model), cloud distributed inference, lightweight model inference on the terminal (edge AI), and external health API linkage. With these configurations, the automation unit realizes improvements in computer technology itself (improved sleep data analysis accuracy, computational efficiency, enhanced user adaptability, improved data manageability), achieving technical progress different from mere business efficiency improvement or business process automation.

The optimization unit can also estimate a user's emotion and adjust device screen brightness based on the estimated emotion. For example, if the user is feeling stressed, the screen brightness is lowered. If the user is relaxed, the normal screen brightness may be maintained. Furthermore, if the user is concentrating, the screen brightness may be increased. By adjusting device screen brightness based on the user's emotion, a more comfortable visual environment is provided. Specifically, the optimization unit collects user input data such as text messages (e.g., “I'm tired today”, “I want to concentrate”), voice commands (e.g., voice waveform data), facial images (e.g., H×W×C RGB images), and biometric sensor data (e.g., heart rate, skin conductance, etc.) as multimodal tensors. The optimization unit preprocesses these data in a preprocessing unit by normalization and vectorization, and inputs them into an AI model for emotion estimation (e.g., BERT-based emotion classification model, multimodal fusion model). Examples of input include text such as “I'm very stressed today”, “I want to concentrate now”, or voice with a calm tone, or facial images with a serious expression. The optimization unit integrates features of text, voice, image, and biometric signals within the model using multi-layer self-attention mechanisms and convolutional layers, and outputs emotion classes (e.g., stress, relaxation, concentration, etc.) and emotion scores (e.g., stress level 0.80, relaxation level 0.10, concentration level 0.10, etc.). Examples of output include probability distributions such as “Stress: 0.85”, “Relaxation: 0.10”, “Concentration: 0.05”. The optimization unit inputs these emotion scores as parameters into a screen brightness control algorithm (e.g., weighted brightness control model, priority scoring model, etc.), and automatically generates screen brightness control policies such as “set screen brightness to 20%” when stress level is high, “set screen brightness to 50%” when relaxation level is high, and “set screen brightness to 80%” when concentration level is high. Examples of output include “Screen brightness 20%”, “Screen brightness 50%”, “Screen brightness 80%”, and so on. The optimization unit sequentially accumulates user feedback (e.g., adoption, rejection, reconfiguration requests for screen brightness, etc.) and new emotion data as learning data, and updates the parameters of the emotion estimation model and screen brightness control model through online learning. As a subsequent process, the generated screen brightness control policy is passed to the device control unit or UI display unit and reflected in real time on the user's terminal. As a technical effect, the optimization unit realizes highly accurate and efficient screen brightness control adapted to the user's emotional state, which is difficult to achieve with conventional static screen brightness settings or simple brightness control, thereby reducing user stress, maintaining concentration, improving satisfaction, and reducing visual fatigue. Applicable fields include smartphones, tablets, business terminals, assistive devices for people with disabilities, and IoT-linked displays. Furthermore, the optimization unit can implement various variations such as cooperation of multiple AI models (e.g., emotion estimation model+screen brightness control model+user behavior analysis model), cloud distributed inference, lightweight model inference on the terminal (edge AI), and external device API linkage. With these configurations, the optimization unit realizes improvements in computer technology itself (improved screen brightness control accuracy, computational efficiency, enhanced user adaptability, improved data manageability), achieving technical progress different from mere business efficiency improvement or business process automation.

Below, the processing flow of Example of the Embodiment is briefly described. Specifically, the present system receives various types of user input data (e.g., text, voice, images, geographic information, operation history, sensor data, etc.), performs normalization, vectorization, and feature extraction in the preprocessing unit, and inputs them into the AI model. In Step 1, the analysis unit analyzes the user's operation using generative AI. For example, the analysis unit monitors operations performed by the user on a smartphone in real time and analyzes the content of those operations. For example, when the user sends a text message, the analysis unit analyzes the content of the message and generates an appropriate reply. The analysis unit can also learn the user's operation patterns using generative AI and grasp operation tendencies. The analysis unit collects input data such as text messages (e.g., “Tell me the schedule for the meeting”, “Send the materials”), voice commands (e.g., voice waveform data), operation history (e.g., application launches, touch events, etc.), and device status information as multidimensional tensors. The analysis unit preprocesses these data in the preprocessing unit by normalization and feature extraction, and inputs them into natural language understanding models or operation classification models (e.g., BERT-based command classification model, CNN-based operation recognition model, etc.). The model extracts operation types and parameters (e.g., application name, date and time, destination, etc.) and passes them to the subsequent automation unit. In Step 2, the automation unit automates the operations analyzed by the analysis unit. For example, the automation unit automatically executes operations that the user frequently performs. For example, the automation unit automatically launches frequently used applications and executes necessary operations. The automation unit can also generate scripts to streamline the user's operations using generative AI. The automation unit inputs the analysis results into an operation automation algorithm (e.g., reinforcement learning-based script generation model, rule-based automation model, etc.) and generates the optimal operation sequence. In Step 3, the learning unit learns the user's operation history. For example, the learning unit records operations performed by the user in the past and learns based on those data. The learning unit analyzes the user's operation patterns using generative AI and optimizes operations. The learning unit collects history data (e.g., operation type, time, frequency, etc.) as time-series vectors and inputs them into a history understanding model (e.g., Transformer-based history encoder, etc.) to extract user-specific tendencies and optimization parameters. In Step 4, the efficiency unit streamlines operations based on the results learned by the learning unit. For example, the efficiency unit preferentially displays frequently used applications and functions to improve operation efficiency. The efficiency unit can also customize application settings and layouts based on the user's preferences and habits using generative AI. The efficiency unit inputs the learning results into a settings/layout optimization model (e.g., UI optimization model, user adaptation model, etc.) and automatically generates the optimal display and operation environment. The output of the AI model at each step includes score distributions, labels, probability values, structured data, recommendation lists, scripts, UI layouts, etc., and as subsequent processing, these are passed to the UI display unit, notification unit, speech synthesis unit, etc., and reflected in real time on the user's terminal or cloud service. As a technical effect, the present system realizes highly accurate and efficient automation and optimization adapted to the user's diverse situations, operation tendencies, and preferences, which are difficult to achieve with conventional static operation automation or single-model inference, thereby improving user experience, streamlining operations, reducing erroneous operations, improving overall system computational efficiency, and enhancing data manageability. Applicable fields include smartphone applications, business terminals, medical and healthcare support, educational applications, assistive devices for people with disabilities, IoT-linked devices, and cloud service platforms.

Step 1: The analysis unit analyzes the user's operation using generative AI. For example, the analysis unit monitors operations performed by the user on a smartphone in real time and analyzes the content of those operations. For example, when the user sends a text message, the analysis unit analyzes the content of the message and generates an appropriate reply. The analysis unit can also learn the user's operation patterns using generative AI and grasp operation tendencies. Step 2: The automation unit automates the operations analyzed by the analysis unit. For example, the automation unit automatically executes operations that the user frequently performs. For example, the automation unit automatically launches frequently used applications and executes necessary operations. The automation unit can also generate scripts to streamline the user's operations using generative AI. Step 3: The learning unit learns the user's operation history. For example, the learning unit records operations performed by the user in the past and learns based on those data. The learning unit analyzes the user's operation patterns using generative AI and optimizes operations. Step 4: The efficiency unit streamlines operations based on the results learned by the learning unit. For example, the efficiency unit preferentially displays frequently used applications and functions to improve operation efficiency. The efficiency unit can also customize application settings and layouts based on the user's preferences and habits using generative AI. Specifically, in Step 1, the analysis unit collects user input data such as text messages (e.g., “Tell me the schedule for the meeting”, “Send the materials”), voice commands (e.g., voice waveform data), operation history (e.g., application launches, touch events, etc.), and device status information as multidimensional tensors, performs normalization and feature extraction in the preprocessing unit, and inputs them into natural language understanding models or operation classification models (e.g., BERT-based command classification model, CNN-based operation recognition model, etc.). The analysis unit extracts operation types and parameters (e.g., application name, date and time, destination, etc.) within the model and passes them to the subsequent automation unit. In Step 2, the automation unit inputs the operation types and parameters analyzed by the analysis unit into an operation automation algorithm (e.g., reinforcement learning-based script generation model, rule-based automation model, etc.), and generates the optimal operation sequence for automatically launching and executing frequently performed operations and frequently used applications. In Step 3, the learning unit collects the user's operation history data (e.g., operation type, time, frequency, etc.) as time-series vectors and inputs them into a history understanding model (e.g., Transformer-based history encoder, etc.) to extract user-specific tendencies and optimization parameters. In Step 4, the efficiency unit inputs the results learned by the learning unit into a settings/layout optimization model (e.g., UI optimization model, user adaptation model, etc.), preferentially displays frequently used applications and functions, and customizes application settings and layouts. The output of the AI model at each step includes score distributions, labels, probability values, structured data, recommendation lists, scripts, UI layouts, etc., and as subsequent processing, these are passed to the UI display unit, notification unit, speech synthesis unit, etc., and reflected in real time on the user's terminal or cloud service. As a technical effect, the present system realizes highly accurate and efficient automation and optimization adapted to the user's diverse situations, operation tendencies, and preferences, which are difficult to achieve with conventional static operation automation or single-model inference, thereby improving user experience, streamlining operations, reducing erroneous operations, improving overall system computational efficiency, and enhancing data manageability. Applicable fields include smartphone applications, business terminals, medical and healthcare support, educational applications, assistive devices for people with disabilities, IoT-linked devices, and cloud service platforms.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned analysis unit, automation unit, learning unit, and optimization unit is implemented by at least one of, for example, the smart device 14 and the data processing apparatus 12. For example, the analysis unit is implemented by a control unit 46A of the smart device 14 and monitors a user's operation in real time and analyzes the operation content. The automation unit is implemented, for example, by a specific processing unit 290 of the data processing apparatus 12 and automates the analyzed operation. The learning unit is implemented, for example, by the control unit 46A of the smart device 14 and learns a user's operation history. The optimization unit is implemented, for example, by the specific processing unit 290 of the data processing apparatus 12 and optimizes operations based on the learned result. The correspondence between each unit and the apparatus or control unit is not limited to the examples described above and various modifications are possible.

### [Second Embodiment]

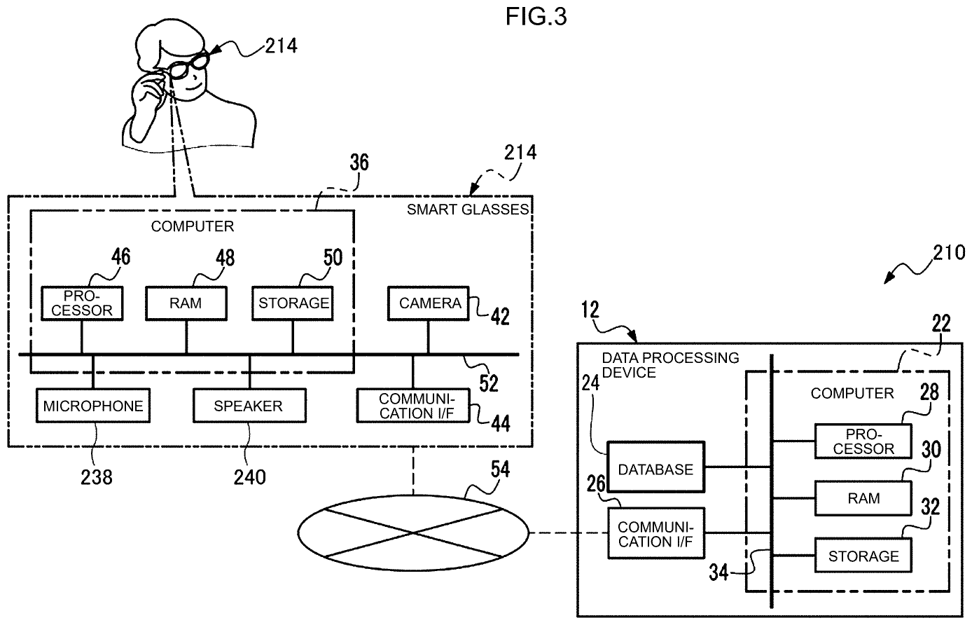

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

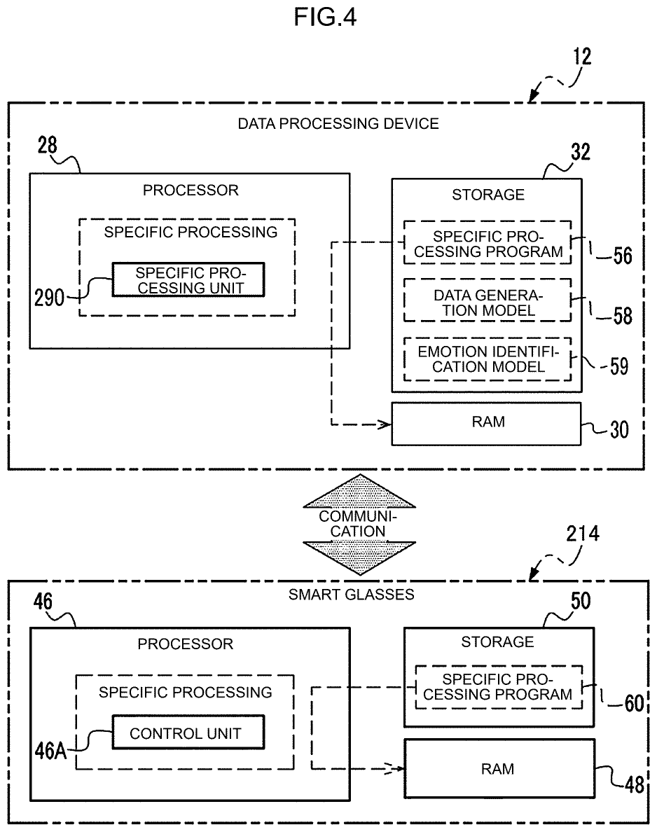

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned analysis unit, automation unit, learning unit, and optimization unit is implemented by at least one of, for example, the smart glasses 214 and the data processing apparatus 12. For example, the analysis unit is implemented by a control unit 46A of the smart glasses 214 and monitors a user's operation in real time and analyzes the operation content. The automation unit is implemented, for example, by a specific processing unit 290 of the data processing apparatus 12 and automates the analyzed operation. The learning unit is implemented, for example, by the control unit 46A of the smart glasses 214 and learns a user's operation history. The optimization unit is implemented, for example, by the specific processing unit 290 of the data processing apparatus 12 and optimizes operations based on the learned result. The correspondence between each unit and the apparatus or control unit is not limited to the examples described above and various modifications are possible.

### [Third Embodiment]

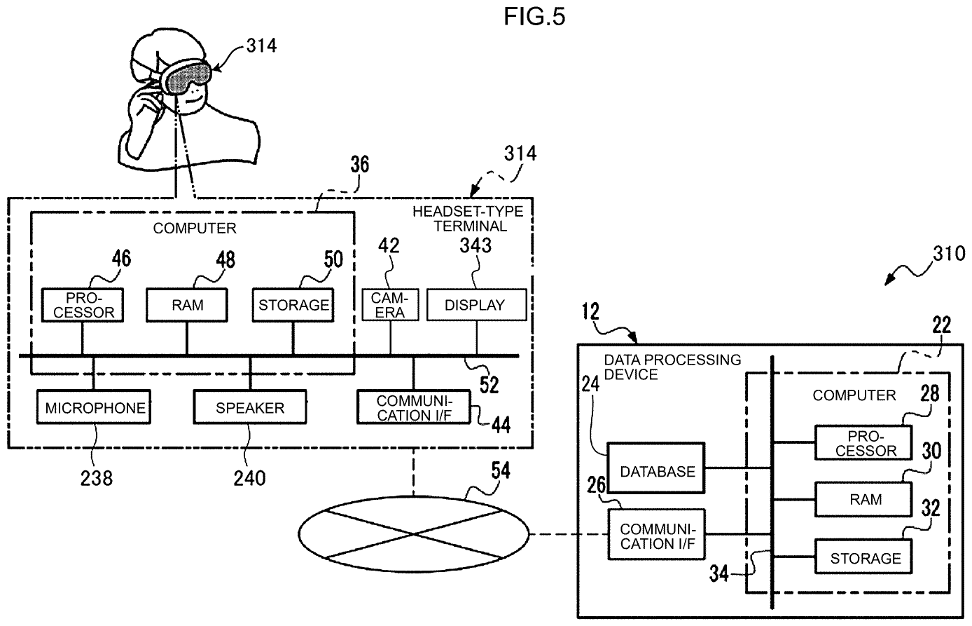

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

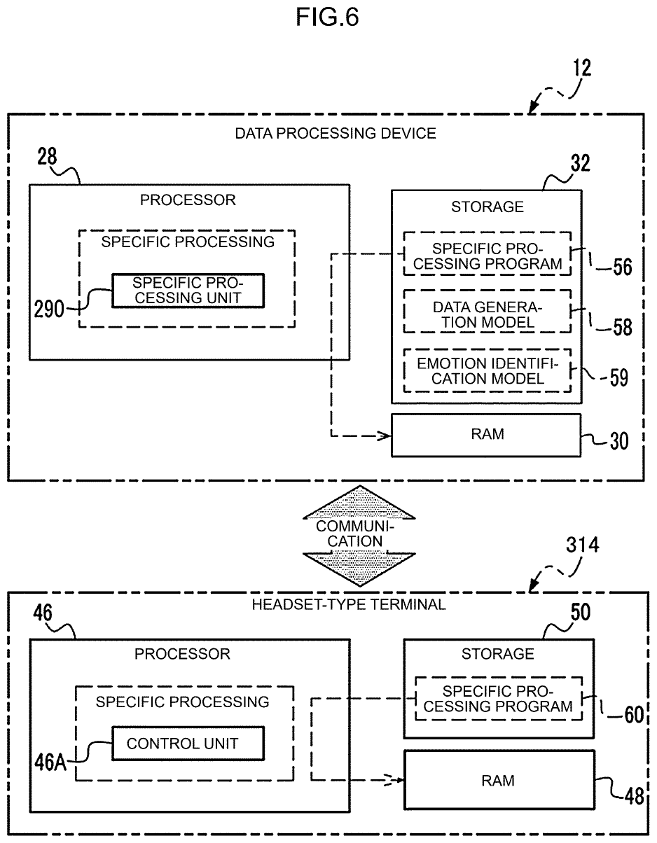

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned analysis unit, automation unit, learning unit, and optimization unit is implemented by at least one of, for example, the headset-type terminal 314 and the data processing apparatus 12. For example, the analysis unit is implemented by a control unit 46A of the headset-type terminal 314 and monitors a user's operation in real time and analyzes the operation content. The automation unit is implemented, for example, by a specific processing unit 290 of the data processing apparatus 12 and automates the analyzed operation. The learning unit is implemented, for example, by the control unit 46A of the headset-type terminal 314 and learns a user's operation history. The optimization unit is implemented, for example, by the specific processing unit 290 of the data processing apparatus 12 and optimizes operations based on the learned result. The correspondence between each unit and the apparatus or control unit is not limited to the examples described above and various modifications are possible.

### [Fourth Embodiment]

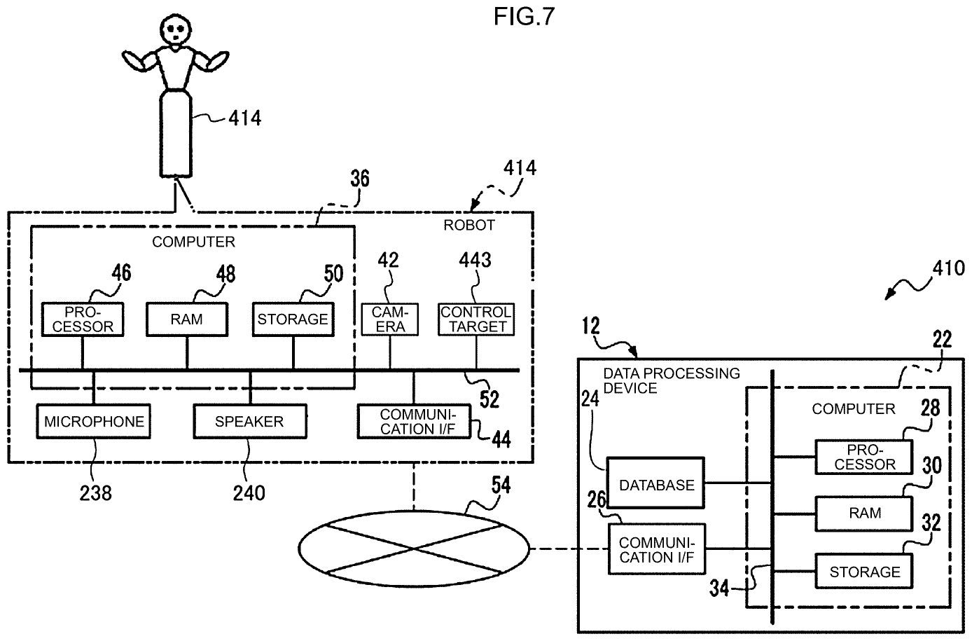

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

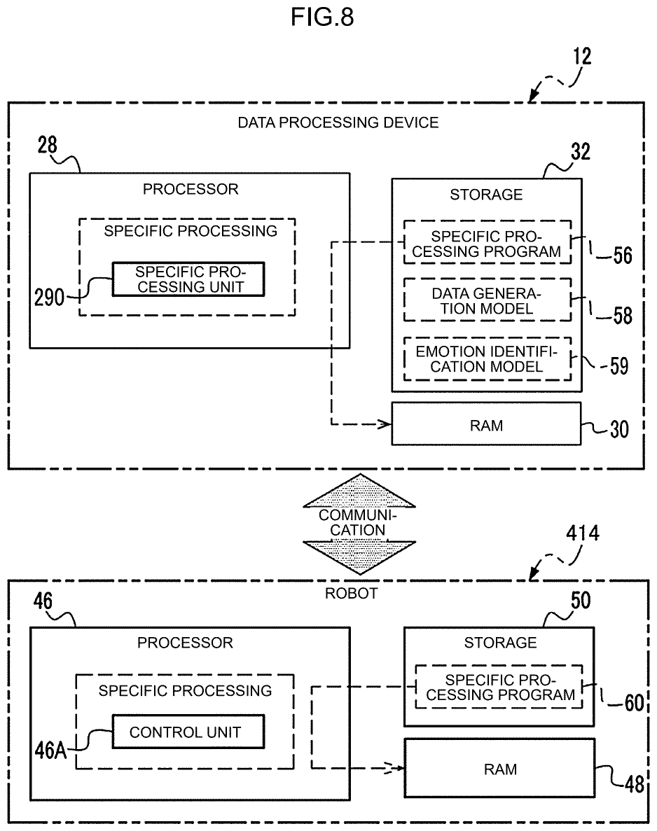

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned analysis unit, automation unit, learning unit, and optimization unit is implemented by at least one of, for example, the robot 414 and the data processing apparatus 12. For example, the analysis unit is implemented by a control unit 46A of the robot 414 and monitors a user's operation in real time and analyzes the operation content. The automation unit is implemented, for example, by a specific processing unit 290 of the data processing apparatus 12 and automates the analyzed operation. The learning unit is implemented, for example, by the control unit 46A of the robot 414 and learns a user's operation history. The optimization unit is implemented, for example, by the specific processing unit 290 of the data processing apparatus 12 and optimizes operations based on the learned result. The correspondence between each unit and the apparatus or control unit is not limited to the examples described above and various modifications are possible.

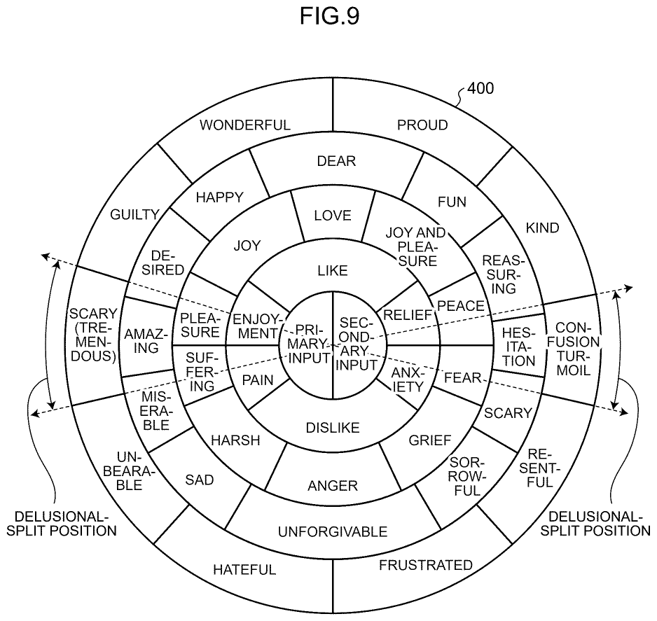

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

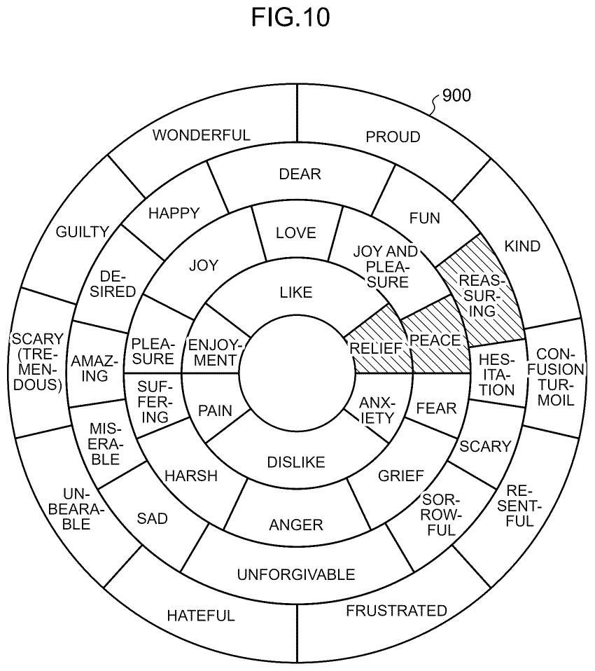

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: an analysis unit configured to analyze a user's operation; an automation unit configured to automate the operation analyzed by the analysis unit; a learning unit configured to learn a user's operation history; and an efficiency unit configured to streamline operations based on a result learned by the learning unit.
(Supplementary Note 2) The system according to Supplementary Note 1, wherein the analysis unit is configured to analyze the content of a text message and automatically generate an appropriate reply.
(Supplementary Note 3) The system according to Supplementary Note 1, wherein the automation unit is configured to analyze a user's calendar and propose an efficient schedule.
(Supplementary Note 4) The system according to Supplementary Note 1, wherein the automation unit is configured to provide highly relevant search results based on a user's search history or preferences.
(Supplementary Note 5) The system according to Supplementary Note 1, wherein the learning unit is configured to learn a user's operation history and preferentially display frequently used applications and functions.
(Supplementary Note 6) The system according to Supplementary Note 1, wherein the optimization unit is configured to customize application settings and layouts based on a user's preferences and habits.
(Supplementary Note 7) The system according to Supplementary Note 1, wherein the automation unit is configured to automate operations of other third-party applications.
(Supplementary Note 8) The system according to Supplementary Note 1, wherein the automation unit is configured to analyze post content in an SNS application and automatically generate appropriate tags and hashtags.
(Supplementary Note 9) The system according to Supplementary Note 1, wherein the automation unit is configured to propose recommended products based on searches in a shopping application.
(Supplementary Note 10) The system according to Supplementary Note 2, wherein the analysis unit is configured to estimate a user's emotion and adjust a method of analyzing a text message based on the estimated emotion.
(Supplementary Note 11) The system according to Supplementary Note 2, wherein the analysis unit is configured to refer to a user's past message history when analyzing the content of a text message to improve analysis accuracy.
(Supplementary Note 12) The system according to Supplementary Note 2, wherein the analysis unit is configured to consider a user's current situation and context when analyzing the content of a text message.
(Supplementary Note 13) The system according to Supplementary Note 2, wherein the analysis unit is configured to estimate a user's emotion and adjust a method of displaying an analysis result based on the estimated emotion.
(Supplementary Note 14) The system according to Supplementary Note 2, wherein the analysis unit is configured to consider a user's geographic location information when analyzing the content of a text message.
(Supplementary Note 15) The system according to Supplementary Note 2, wherein the analysis unit is configured to refer to a user's social media activity when analyzing the content of a text message.
(Supplementary Note 16) The system according to Supplementary Note 3, wherein the automation unit is configured to estimate a user's emotion and adjust a method of schedule proposal based on the estimated emotion.
(Supplementary Note 17) The system according to Supplementary Note 3, wherein the automation unit is configured to refer to a user's past schedule history when analyzing a calendar to improve proposal accuracy.
(Supplementary Note 18) The system according to Supplementary Note 3, wherein the automation unit is configured to consider a user's current situation and context when analyzing a calendar to make proposals.
(Supplementary Note 19) The system according to Supplementary Note 3, wherein the automation unit is configured to estimate a user's emotion and determine a priority of schedule proposals based on the estimated emotion.
(Supplementary Note 20) The system according to Supplementary Note 3, wherein the automation unit is configured to consider a user's geographic location information when analyzing a calendar to make proposals.
(Supplementary Note 21) The system according to Supplementary Note 3, wherein the automation unit is configured to refer to a user's social media activity when analyzing a calendar to make proposals.
(Supplementary Note 22) The system according to Supplementary Note 4, wherein the learning unit is configured to estimate a user's emotion and select learning data based on the estimated emotion.
(Supplementary Note 23) The system according to Supplementary Note 4, wherein the learning unit is configured to refer to past learning data during learning to optimize a learning algorithm.
(Supplementary Note 24) The system according to Supplementary Note 4, wherein the learning unit is configured to analyze a user's operation history during learning to improve learning accuracy.
(Supplementary Note 25) The system according to Supplementary Note 4, wherein the learning unit is configured to estimate a user's emotion and adjust a frequency of learning based on the estimated emotion.
(Supplementary Note 26) The system according to Supplementary Note 4, wherein the learning unit is configured to consider a user's geographic location information during learning to select learning data.
(Supplementary Note 27) The system according to Supplementary Note 4, wherein the learning unit is configured to refer to a user's social media activity during learning to select learning data.
(Supplementary Note 28) The system according to Supplementary Note 5, wherein the optimization unit is configured to estimate a user's emotion and adjust application settings and layouts based on the estimated emotion.
(Supplementary Note 29) The system according to Supplementary Note 5, wherein the optimization unit is configured to refer to a user's past operation history during optimization to improve optimization accuracy.
(Supplementary Note 30) The system according to Supplementary Note 5, wherein the optimization unit is configured to consider a user's current situation and context during optimization.
(Supplementary Note 31) The system according to Supplementary Note 5, wherein the optimization unit is configured to estimate a user's emotion and determine a priority of optimization based on the estimated emotion.
(Supplementary Note 32) The system according to Supplementary Note 5, wherein the optimization unit is configured to consider a user's geographic location information during optimization.
(Supplementary Note 33) The system according to Supplementary Note 5, wherein the optimization unit is configured to refer to a user's social media activity during optimization.

What is claimed is:

1. A system comprising:
a communication interface configured to communicate with a client terminal via a packet-switched network;
a memory storing a data generation model obtained by deep learning on a neural network, and an emotion identification model; and
circuitry configured to:
receive, from the client terminal via the communication interface, operation data comprising at least one of touch event data, application launch data, or voice command data;
analyze the operation data using the data generation model to extract an operation pattern feature vector;
estimate an emotion of a user by applying the emotion identification model to sensor data received from the client terminal;
generate, using the data generation model, inference data comprising at least one of a next operation prediction, an operation sequence recommendation, or an interface configuration parameter, based on the operation pattern feature vector and the estimated emotion; and
transmit the inference data to the client terminal via the communication interface and the packet-switched network, the inference data causing the client terminal to execute an automated operation or adjust a display configuration.

2. The system according to claim 1, wherein the operation data further comprises time-series data representing a sequence of user interactions, the time-series data being stored as a multidimensional tensor having dimensions corresponding to a number of events, time steps, and features.

3. The system according to claim 1, wherein the circuitry is further configured to preprocess the operation data by performing normalization and vectorization, and to convert the preprocessed operation data into abstract feature vectors using an encoder comprising at least one of a convolutional neural network or a Transformer-based model.

4. The system according to claim 1, wherein the circuitry is further configured to analyze a text message received from the client terminal using a natural language understanding model and to generate a reply text based on tone and context of the text message.

5. The system according to claim 4, wherein the circuitry is further configured to adjust at least one of a length, a politeness level, or an information amount of the reply text based on the estimated emotion.

6. The system according to claim 1, wherein the circuitry is further configured to analyze calendar data received from the client terminal to generate a schedule proposal, the schedule proposal being determined using at least one of a reinforcement learning algorithm or a constraint satisfaction problem solver.

7. The system according to claim 6, wherein the circuitry is further configured to adjust a schedule proposal policy based on the estimated emotion, such that when the estimated emotion indicates stress, the circuitry generates a schedule proposal with increased break times, and when the estimated emotion indicates relaxation, the circuitry generates a schedule proposal optimized for efficiency.

8. The system according to claim 1, wherein the circuitry is further configured to analyze search query data received from the client terminal using a query understanding model and a ranking model to generate a list of search results with relevance scores, the relevance scores being calculated based on semantic similarity between the search query data and a past search history of the user.

9. The system according to claim 1, wherein the circuitry is further configured to learn an operation frequency distribution for each application based on operation history data stored in a database, and to generate a priority display list indicating applications to be preferentially displayed on the client terminal.

10. The system according to claim 1, wherein the circuitry is further configured to extract preference clusters and habit patterns from setting change history data using at least one of a clustering algorithm or a Transformer-based encoder, and to generate optimized setting parameters and layout configurations based on the extracted preference clusters and habit patterns.

11. The system according to claim 1, wherein the circuitry is further configured to analyze operation logs of a third-party application received from the client terminal and to generate an automation script for automatically executing operations of the third-party application.

12. The system according to claim 1, wherein the circuitry is further configured to analyze post content data received from the client terminal and to generate tag candidates with associated scores using a tag generation model comprising a multimodal fusion model.

13. The system according to claim 1, wherein the circuitry is further configured to adjust a timing of receiving the operation data from the client terminal based on the estimated emotion, such that when the estimated emotion indicates stress, the circuitry delays the receiving, and when the estimated emotion indicates relaxation, the circuitry receives the operation data immediately.

14. The system according to claim 1, wherein the circuitry is further configured to adjust a level of detail of the inference data based on the estimated emotion, such that when the estimated emotion indicates stress, the circuitry generates concise inference data, and when the estimated emotion indicates relaxation, the circuitry generates detailed inference data.

15. The system according to claim 1, wherein the circuitry is further configured to receive geographic location information from the client terminal and to adjust a priority of the operation data to be analyzed based on a spatial distance between a current location indicated by the geographic location information and a location associated with the operation data.

16. The system according to claim 1, wherein the circuitry is further configured to receive social media activity data from the client terminal, analyze the social media activity data using a natural language processing model to extract interest topics, and adjust the inference data based on the extracted interest topics.

17. The system according to claim 1, wherein the circuitry is further configured to determine a priority of generating the inference data based on an importance score calculated from the operation data, such that operation data having a high importance score is processed with a higher priority.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model obtained by deep learning on a neural network, and an emotion identification model; and
circuitry configured to:
receive, from the client terminal via the communication interface, operation data comprising at least one of touch event data captured by the touch panel, application launch data, or voice command data captured by the microphone;
preprocess the operation data by performing normalization and vectorization to generate a multidimensional feature tensor;
analyze the preprocessed operation data using the data generation model to extract an operation pattern feature vector;
estimate an emotion of a user by applying the emotion identification model to at least one of voice data captured by the microphone or image data captured by the camera;
generate, using the data generation model, inference data comprising at least one of a next operation prediction, an operation sequence recommendation, or an interface configuration parameter, based on the operation pattern feature vector and the estimated emotion;
adjust at least one of a level of detail, an expression style, or a format of the inference data based on the estimated emotion; and
transmit the inference data to the client terminal via the communication interface, the inference data causing the client terminal to execute an automated operation or present the inference data to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model obtained by deep learning on a neural network and an emotion identification model, the method comprising:
receiving, from a client terminal via the communication interface and a packet-switched network, operation data comprising at least one of touch event data, application launch data, or voice command data;
analyzing the operation data using the data generation model to extract an operation pattern feature vector;
estimating an emotion of a user by applying the emotion identification model to sensor data received from the client terminal;
generating, using the data generation model, inference data comprising at least one of a next operation prediction, an operation sequence recommendation, or an interface configuration parameter, based on the operation pattern feature vector and the estimated emotion; and
transmitting the inference data to the client terminal via the communication interface and the packet-switched network, the inference data causing the client terminal to execute an automated operation or adjust a display configuration.
